(19) United States
(12) Patent Application Publication
(10) Pub. No.: US 2012/0215554 A1
(43) Pub. Date: Aug. 23, 2012

(54) PHARMACEUTICAL DATA INTEGRATION & ANALYSIS TOOL

(75) Inventor: Peter Yurkovich, University City, MO (US)

(73) Assignee: ELECTRONIC DRUG INFORMATION SYSTEMS SOLUTIONS, LLC, University City, MO (US)

(21) Appl. No.: 13/400,112

(22) Filed: Feb. 19, 2012

Related U.S. Application Data
(60) Provisional application No. 61/444,749, filed on Feb. 20, 2011.

(51) Int. Cl. G06Q 50/22

(52) U.S. Cl. 705/2

(57) ABSTRACT

A system and processes are used to strategically evaluate opportunities for developing and producing generic pharmaceuticals. The system includes a knowledge driven optimization tool that efficiently analyzes pharmaceutical opportunities after merging pharmaceutical records from multiple sources. The analytical system allows users to filter the integrated records and evaluate the integrated records using patterns in the data. The system calculates historical trends of generic pharmaceutical compositions, and a user can select a market entry template that is based on the historical trends which the system then applies to a current pharmaceutical composition to create a forecast.

### CROSS-REFERENCE TO RELATED APPLICATIONS

This application claims priority to U.S. Provisional Patent Application Ser. No. 61/444,749 filed Feb. 20, 2011 and titled “PHARMACEUTICAL DATA INTEGRATION & ANALYSIS TOOL”, which is incorporated in its entirety herein.

### STATEMENT REGARDING FEDERALLY SPONSORED RESEARCH

Not Applicable.

### APPENDIX

Not Applicable.

### BACKGROUND OF THE INVENTION

The present invention relates generally to a system and process for strategically evaluating opportunities for developing and producing generic pharmaceuticals. More particularly, the present invention relates to a knowledge driven optimization tool for efficiently analyzing pharmaceutical opportunities.

Pharmaceutical manufactures do not have a problem obtaining data; the problem is integrating the data in a cohesive system so it becomes information. Most pharmaceutical manufacturers purchase pharmaceutical sales and unit data from a third party source, such as IMS Health or Wolters Kluwer (Medi-Span). Additionally, pharmaceutical manufacturers will purchase pharmaceutical price data from First Data Bank (FDB). Each one of these data sources has its own specific query tool that the users must learn in order to find data of use. Typically, users of these software tools will need to attend a class for each one of the tools in order to effectively put them to use. Pharmaceutical manufacturers will also use regulatory data from the Food and Drug Administration (FDA) and Clinical Trials, and once again, the users must learn how to use the various FDA web sites and the Clinical Trials web site to find specific data of interest. Additionally, pharmaceutical manufacturers will follow on-line news services to stay on top of the latest breaking news and get stock quotes and other financial metrics for the pharmaceutical industry. All of these sources are completely separate, and the data returned cannot be used as inputs for searches in another data set in any automated manner. Additionally, data cannot be entered into each system and saved. Any additional work or analysis must be done outside of each data source.

Once all the data has been extracted, analysts must prepare the data for analysis in yet another program. Each user looking for data might have different presentation styles where some data could be missing, making an overall analysis of several projects difficult and could create errors due to handling the data. The other difficulty is the age of the data. Each data set gets updated at different intervals, so decisions could be made based on out-of-date or even conflicting data. With the current analytical systems, the manufacturer has data located across servers, in spreadsheets linked to other spreadsheets in their network, making it difficult to maintain and access the data that has been extracted and manipulated in the systems. The manufacturer must hire people just to research data, forecast the data, analyze the data and maintain the data. This is a very inefficient system for running a business in an industry that moves very fast.

Accordingly, there is a need in the pharmaceutical industry to automatically integrate the data that is currently being obtained from multiple sources.

### SUMMARY OF THE INVENTION

With mounting pressures from a crowded, worldwide industry, speed to market becomes even more important for pharmaceutical manufacturers. Gathering competitive intelligence on the market becomes key to making decisions on where to focus company resources. Access to this intelligence is available, but analyzing the intelligence can be difficult due to the volumes of information available from so many sources. Time is needed to digest the intelligence to make proper decisions. While this intelligence is being gathered, filtered, combined and presented, the intelligence has been changing, making it difficult to make timely decisions. The present invention, Electronic Drug Information System (EDIS), is an Enterprise Solution to this problem. EDIS combines data from sources that provide pricing, sales, competitors, regulatory, clinical trials, stock data and live news alerts. EDIS does all the gathering, filtering, combining and presentation of intelligence in one place so a pharmaceutical manufacturer can focus on making decisions to become more profitable. EDIS allows for pharmaceutical manufacturers to investigate segments of the market that may have profit potential by giving the big picture view down to the NDC level of data. Users can mine the intelligence instead of researching individual drugs, across several data sources, one at a time for study in the most up to date software application available.

In addition to performing an automatic integration of the pharmaceutical data that is currently being obtained from multiple sources, the present invention provides an analytical tool and system for the efficient evaluation of the integrated data according to optimization schemes that analysts can select from the analytical tool's knowledge base and can specify according to their own preferences.

Accordingly, the present invention eliminates the problems of the current systems, integrating the data sources that are available in one analytical tool that allows the users to leverage the strength of all the data simultaneously and gives better insights into the opportunities in the pharmaceutical industry. The present invention at least provides the following benefits:
Data all in one place: sales, pricing, regulatory, clinical trials, product development, listed patent information, forecasts, industry news, public company financial metrics, stock quotes and portfolio rankings
View all brand/generic substitutions in one screen
FDA data integrated into system—manufacturer does not have to worry about FDA changing data feeds
One product tool to learn
Ability to mine data across all data elements at once
Ability to forecast using mined data
All users share same data and have comparable data-mining abilities

The present invention is embodied in a software program operated by a computer processor that integrates pharmaceutical data so that it can be more efficiently used for competitive business research and planning. The program uses several approaches to evaluate various data sets that are purchased and gathered from free sites by pharmaceutical or pharmaceutical distribution companies in order to make one complete set of data that is simpler than current manual methods. Without this software, each data set is typically queried individually, looking for specific answers in each set, and all the data must be brought together using another software program for analysis. Each set of data does not have one common data element to make full integration easily possible. A fully integrated data set allows for transformation of data into business intelligence giving an informational advantage that was not possible before the creation of the present invention. By combining the data sets into a single set through the software, manufactures can find new avenues for profit generation and see the industry as a whole instead of in small segments. The software creates data views and reports to be used in corporate strategy, product strategy, forecasting, portfolio ranking, drug development assessment and competitive threat analysis.

Data analysis is not static, and installed data view and reports are continually updated and easily recreated as new data is provided, allowing interpretation and actionable decision making by personnel not typically involved in market analyses. Additionally, all pharmacy data is in one place to prevent duplication of efforts or incorrect reporting of data

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawing, FIGS. 1-25, wherein:

FIG. 1 is a schematic of an Electronic Drug Information System formed in accordance with an embodiment;

FIG. 2 is a schematic of an Electronic Drug Information System formed in accordance with another embodiment;

FIGS. 3A-3D are screenshots of an FDA table as displayed by at least one of the Electronic Drug Information Systems shown in FIGS. 1 and 2;

FIG. 4 is a screenshot of a product screen as displayed by at least one of the Electronic Drug Information Systems shown in FIGS. 1 and 2;

FIGS. 5A-5C are screenshots of an Electronic Orange Book screen as displayed by at least one of the Electronic Drug Information Systems shown in FIGS. 1 and 2;

FIGS. 6A-6B are screenshots of a Drugs@FDA screen as displayed by at least one of the Electronic Drug Information Systems shown in FIGS. 1 and 2;

FIG. 6C is a screenshot of a Drugs@FDA Therapeutic Equivalents screen as displayed by at least one of the Electronic Drug Information Systems shown in FIGS. 1 and 2;

FIG. 6D is a screenshot of an IMS Sales Graphical Display screen as displayed by at least one of the Electronic Drug Information Systems shown in FIGS. 1 and 2;

FIG. 6E is a screenshot of a FDB Prices screen as displayed by at least one of the Electronic Drug Information Systems shown in FIGS. 1 and 2;

FIG. 6F is a screenshot of an IMS/FDB Details screen as displayed by at least one of the Electronic Drug Information Systems shown in FIGS. 1 and 2;

FIG. 7 is a screenshot of a Manufacturers screen as displayed by at least one of the Electronic Drug Information Systems shown in FIGS. 1 and 2;

FIG. 8 is a screenshot of a Current Pricing screen as displayed by at least one of the Electronic Drug Information Systems shown in FIGS. 1 and 2;

FIG. 9 is a screenshot of an Evaluation screen as displayed by at least one of the Electronic Drug Information Systems shown in FIGS. 1 and 2;

FIG. 10 is a screenshot of a Forecast screen as displayed by at least one of the Electronic Drug Information Systems shown in FIGS. 1 and 2;

FIG. 11 is a screenshot of a Pipeline screen as displayed by at least one of the Electronic Drug Information Systems shown in FIGS. 1 and 2;

FIG. 12 is a screenshot of a Forecast Template Report screen as displayed by at least one of the Electronic Drug Information Systems shown in FIGS. 1 and 2;

FIG. 13 is a screenshot of a Forecast Template Selection screen as displayed by at least one of the Electronic Drug Information Systems shown in FIGS. 1 and 2;

FIG. 14 is a screenshot of a Graphical Competitor Share Screen as displayed by at least one of the Electronic Drug Information Systems shown in FIGS. 1 and 2;

FIG. 15 is a screenshot of a Tabular Competitor Share Screen as displayed by at least one of the Electronic Drug Information Systems shown in FIGS. 1 and 2;

FIG. 16 is a screenshot of a Forecast screen for patent Information as displayed by at least one of the Electronic Drug Information Systems shown in FIGS. 1 and 2;

FIG. 17 is a screenshot of a Regression analysis Trending screen as displayed by at least one of the Electronic Drug Information Systems shown in FIGS. 1 and 2;

FIG. 18 is a screenshot of a Rankings screen as displayed by at least one of the Electronic Drug Information Systems shown in FIGS. 1 and 2;

FIG. 19 is a screenshot of a Hotspot Report screen as displayed by at least one of the Electronic Drug Information Systems shown in FIGS. 1 and 2;

FIG. 20A is a screenshot of a USC Hotspot Detail Report screen as displayed by at least one of the Electronic Drug Information Systems shown in FIGS. 1 and 2;

FIG. 20B is a screenshot of a Product Hotspot Detail Report screen as displayed by at least one of the Electronic Drug Information Systems shown in FIGS. 1 and 2;

FIG. 21 is a screenshot of a Clinical Trials Data Flows screen as displayed by at least one of the Electronic Drug Information Systems shown in FIGS. 1 and 2;

FIG. 22 is a screenshot of a Clinical Trials screen as displayed by at least one of the Electronic Drug Information Systems shown in FIGS. 1 and 2;

FIG. 23 is a screenshot of a RSS Reader screen as displayed by at least one of the Electronic Drug Information Systems shown in FIGS. 1 and 2;

FIG. 24 is a screenshot of a RSS Search Terms screen as displayed by at least one of the Electronic Drug Information Systems shown in FIGS. 1 and 2; and

FIG. 25 is a screenshot of an Alerts screen as displayed by at least one of the Electronic Drug Information Systems shown in FIGS. 1 and 2.

### DETAILED DESCRIPTION OF THE PREFERRED EMBODIMENTS

The present invention will become more fully understood from the detailed description and the accompanying drawings as particularly identified below. The following description of the preferred embodiment(s) is merely exemplary in nature and is in no way intended to limit the invention, its application, or uses.

There are two primary inventions in the Electronic Drug Information System (EDIS) of the present invention. First, there is the data integration system and associated processes that merge pharmaceutical data records from multiple sources so that the data can be efficiently analyzed. Second, there is the analytical system and associated processes that are used to evaluate the integrated data records. Each of these inventions is described in detail below with reference to the accompanying illustrations.

### Data Integration

Generic and branded pharmaceutical companies purchase data from vendors in order to make decisions on which products to develop and purchase. The activities associated with the purchased data include researching new drugs, assessing competitive drugs, evaluating drug categories, analyzing sales volumes and pricing. Each of these activities is put together as they forecast sales potential for new or existing drugs. The data is collected and sold by various companies, the largest of which are IMS, First Data Bank, Wolters Kluwer and others. Additional important competitive drug research information is available from the government (FDA) at no cost. The FDA data is used to look up product exclusivity granted by the FDA, listed patents, drug codes, and more. Also, at no cost data from Clinical Trials is integrated to determine what new drugs other pharmaceutical manufacturers are investigating.

Each of the data sets listed above just present data. As one searches the data, no analysis or guidance is offered. The user must interpret the data in the correct way and have a full understanding of the data if they attempt to combine the various sets. Generic and branded companies expend considerable effort and time to assimilate the various data sets as standalone products. Attempting to combine any dataset is very difficult due to the different data structures used by each collecting entity.

Currently, individuals searching these data sets have specific questions in mind, such as “How many and which generic companies make drug X; what is the dollar volume and unit size of each; and what is the percentage of market share held by each over a three year time period?” For the answer to these questions, the customer needs to use a multiple products, but these products do not work together, and the user cannot run a single query through all of the products' data sets. From a product such as IMS, the user can obtain part of the information needed. If the researcher has a wide-ranging understanding of how IMS is structured, the user would know how to look up the chemical compound in addition to the brand name drug in order to build a complete set of data. In addition, if the researcher wishes to see when the FDA-recognized Orange Book patents expire, current pricing per bottle, or therapeutic equivalents (other drugs able to be substituted) for each of these, they must go to different data sets and manually lookup the information and compile it for each drug. The result is a static point-in-time analysis that is an extremely time-consuming process of cutting and pasting data to one place for analysis and report construction.

A truly robust analysis of the data demands consolidation of the different sets in one place. Spending the millions of dollars required to launch even a generic drug should not be based upon piecemeal research that is incomplete and static as the compilations are built.

The Electronic Drug Information System (EDIS) is a software program for competitive drug research that correlates pharmaceutical market datasets with the FDA drug data in a unique way that creates both data views and standardized reports for use in strategy, presentations, drug development assessment and competitive threat analysis among many other uses. The software merges the specified data of interest across the various data sets such that drug development strategy will be expedited and clear; answers to “what if” questions are quick; and all angles of inquiry across the competing manufacturers, drug launch timing, competing drugs and therapeutic areas could be extracted by almost anyone in the organization.

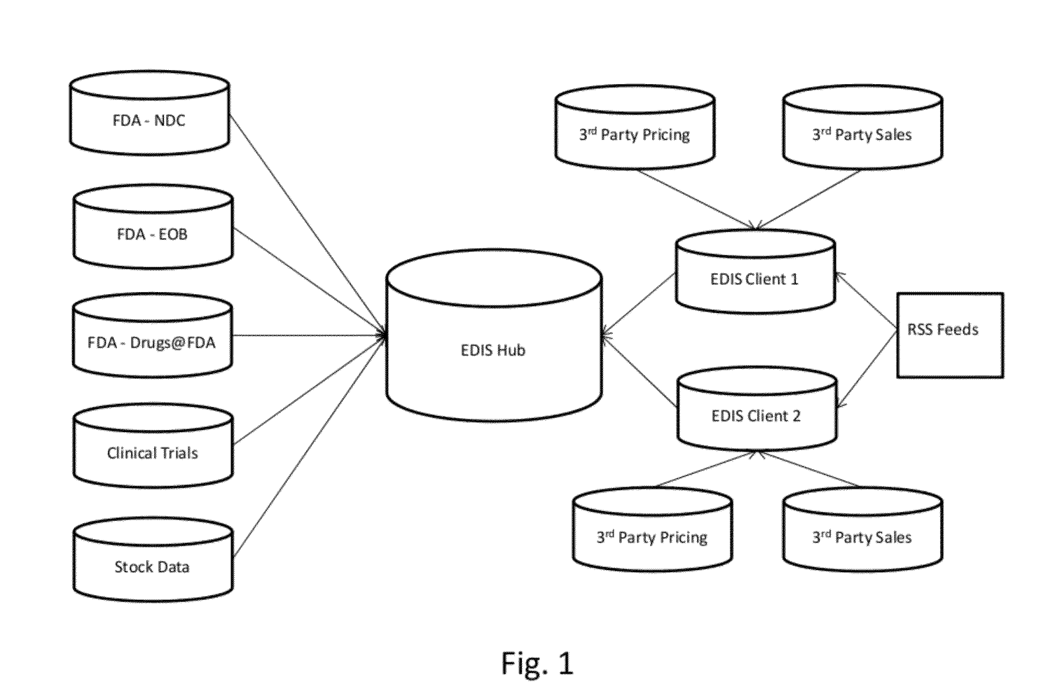

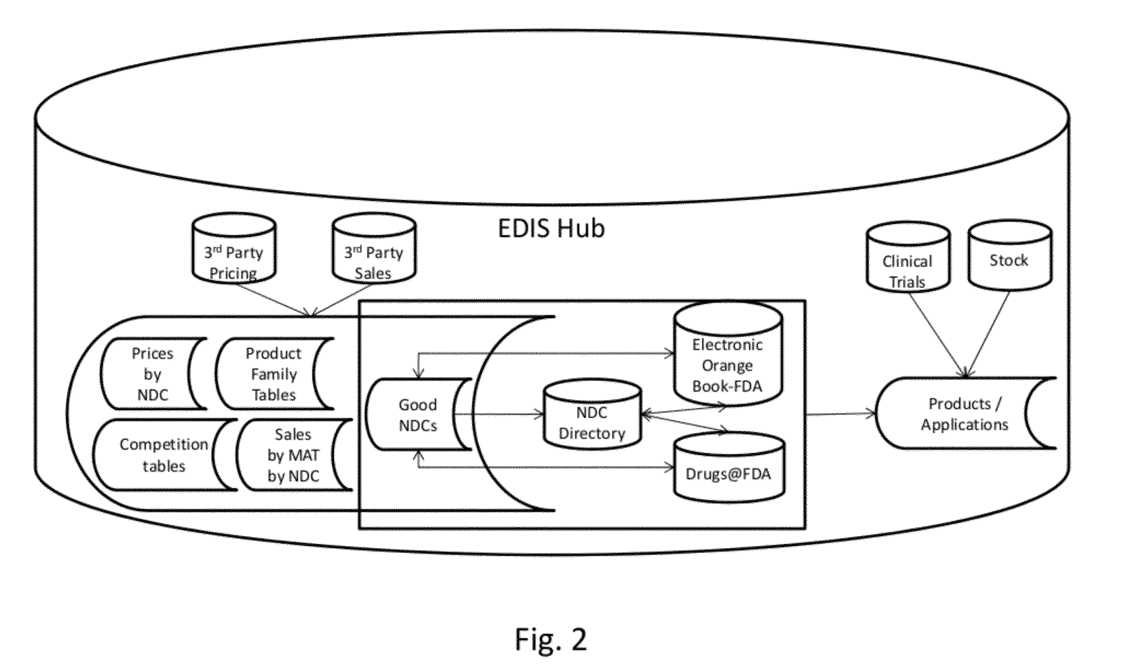

As shown in FIGS. 1 and 2, the EDIS software links data sets from third parties, such as IMS and First Data Bank to the Drugs@FDA, the Electronic Orange Book (EOB—FDA data on patents, drug approvals and date of market exclusivity protection), the National Drug Code (NDC) directory, stock quotes, RSS news feeds and ClinicalTrials.gov. The USPTO (US Patent and Trademark Office) site information may also be linked in the software, as well as others, as customers request and the product continues to develop.

Integrating the FDA regulatory data to the third party sales/unit/pricing data is the starting point of the present invention. The regulatory data contains the Drug Exclusivity Date, Drug patent Expiration Date and the Drug Approval Date. The best unique identifier for an individual drug is the NDC (National Drug Code).

As shown in the listings below, the third party data identifies the NDC with precision for each drug.

Data from IMS
Field: NDC_NO
EDIS Table: dbo_DRUG_MART_IMS_FDB_{—}36M_DIM

Data from First Data Bank:
Field: NDC
EDIS Table: dbo_DRUG_MART_FDB_PRICE_DIM

After downloading and organizing the FDA data from three sources: 1) Electronic Orange Book, 2) Drugs@FDA and 3) NDC directory; the software has the three main FDA tables listed below.

dbo_FDA_DRG_tbl=Drugs@FDA (no NDC)

dbo_EOB_vw=Electronic Orange Book (EOB) (no NDC)

dbo_FDA_NDC_tbl=NDC directory (has NDCs)

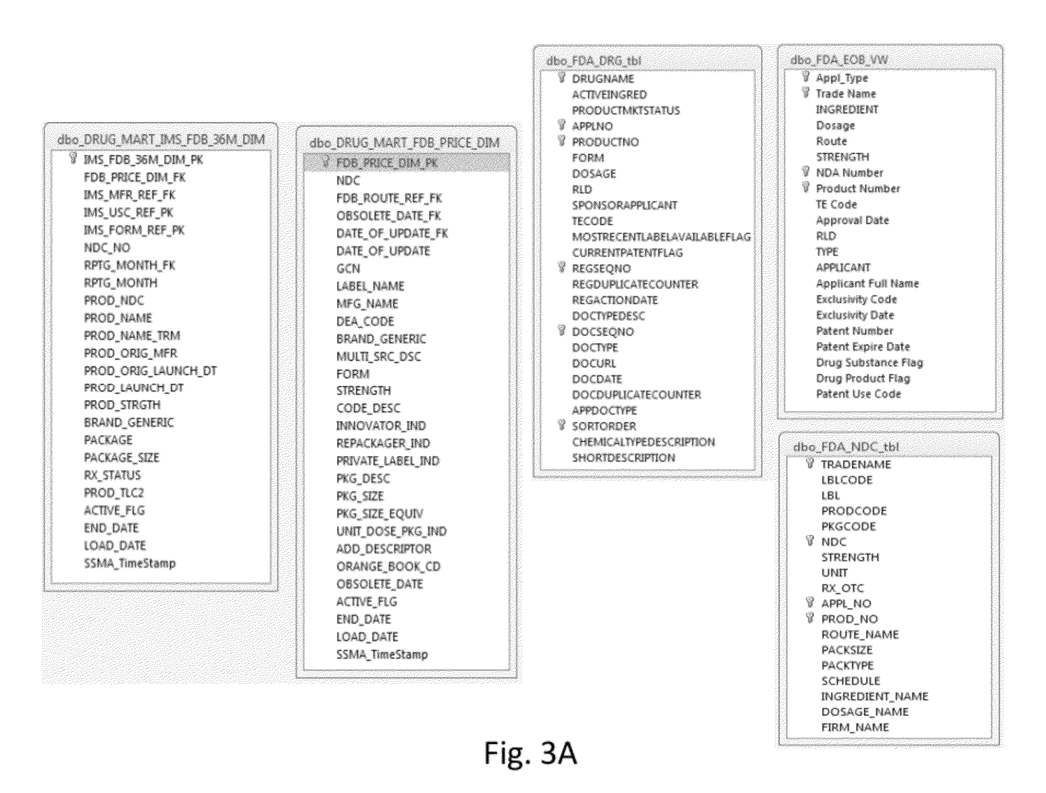

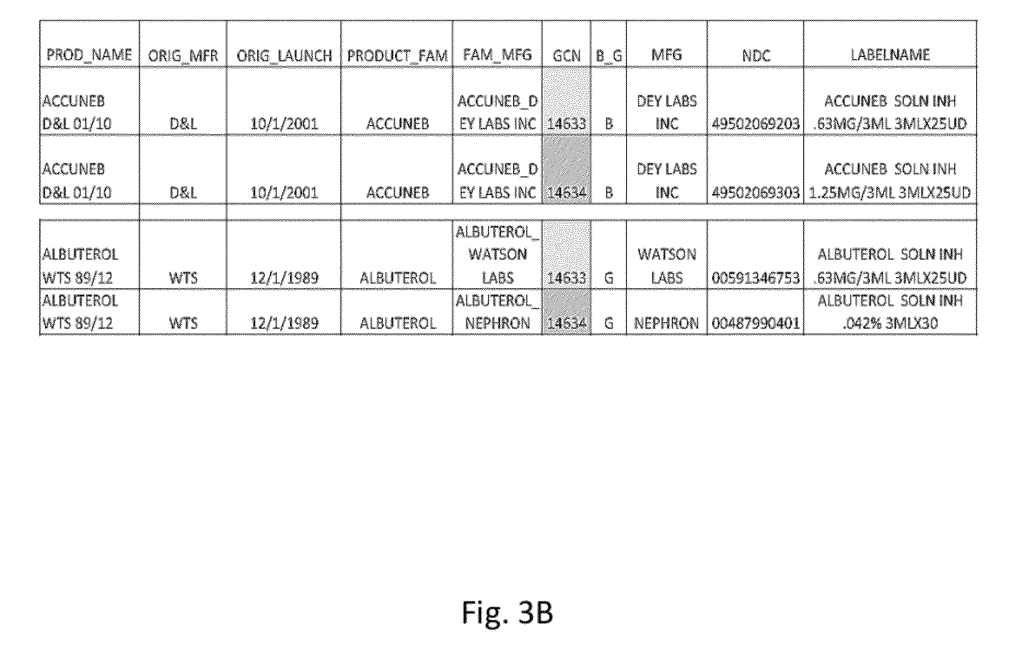

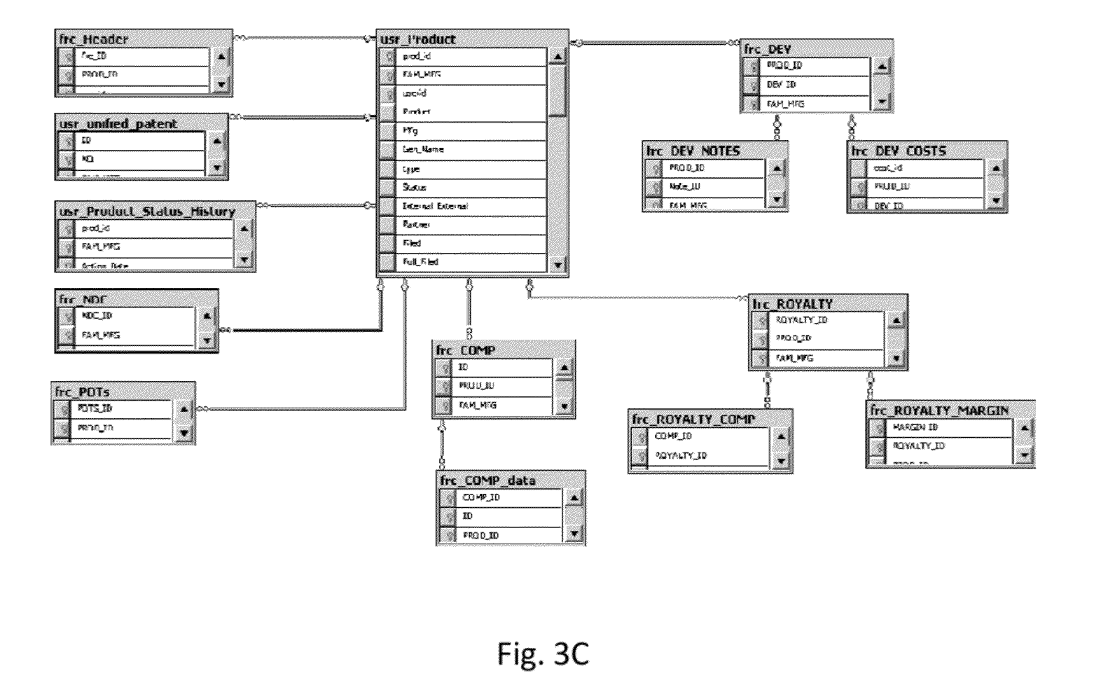

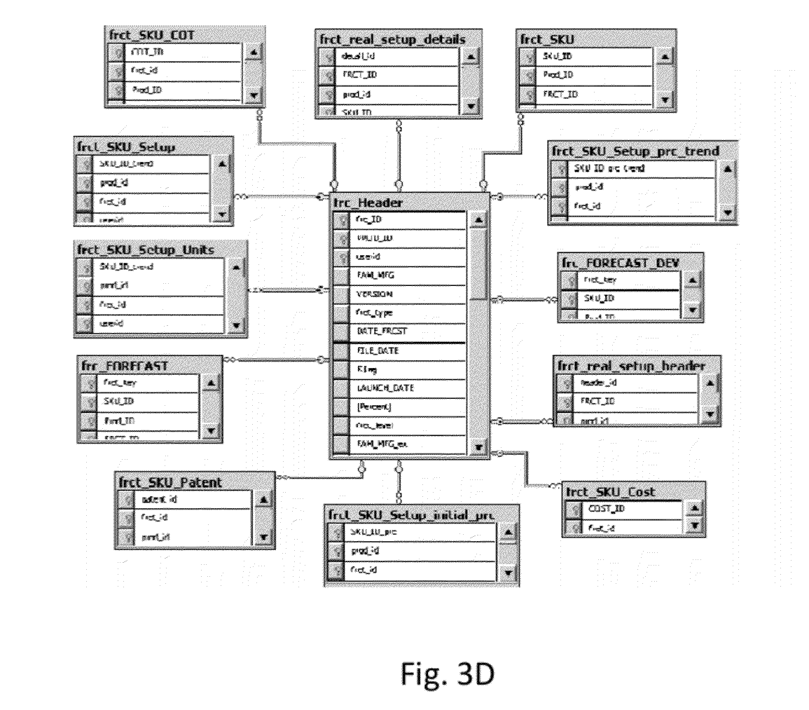

The listings in these tables are shown in FIG. 3A.

As indicated above, the data records from these various third party and government sources are periodically updated. The schedules for the updates differ according to the source. All updates but the RSS feeds are performed at the EDIS HUB at prescribed intervals. The FDA data are updated at different intervals in complete data sets. The Electronic Orange Book (EOB) is updated monthly, and the data merged into the EDIS database includes the active ingredient, applicant name, trade name, patent number, and application number. The information from Drugs@FDA is updated every week, and the data merged into the EDIS database includes the drug labels, therapeutically equivalent drugs, active ingredient, sponsor applicant, and application number (patent application). The National Drug Code (NDC) Directory is updated semimonthly and includes the NDC number, active ingredient, labeler name, trade name, and application number (patent application). The Clinical Trials data is updated daily and includes information on drugs in development for either branded or generic designation. The Stock Quotes data is updated every ten minutes via a web service based upon stock tickers supplied by the end user. The RSS Feeds are defined by the end user and are updated upon client EDIS startup or request. As discussed in detail below, before the NDC data is merged into the EDIS database, a scrub is performed on each part of the NDC code to make sure it matches the eleven digit specification from the 3rd party sources and the other FDA sources.

The First Data Bank (FDB) and IMS data get updated once a month on different days, and the data from these sources is merged directly into the EDIS HUB database from one of the client applications. The IMS Data typically includes the most recent three (3) years of data in each update, including the drug details (NDC, product name, manufacturer, strength, size, dose, route, USC codes, etc.), drug sales data by NDC, by month, and by sales channel, drug unit sales data by NDC, by month, by sales channel. The FDB data also includes the drug details (NDC, GCN, label name, manufacturer, strength, size, dose, route, USC codes, etc.), drug pricing data by NDC, the initial price and three (3) most recent changes.

The various data sources use a different title for the drug name field (trade field, label field or product field). Regardless of the particular title used for this field, the data providers use their respective fields to define the name of the product for sale. The data providers have different levels of detail for the data that is entered into this field, with some including the manufacturer, date of original sale, size, strength, or dose. This adds to the challenge in the task of accurately merging the datasets. The name under which the drug is sold is in the label field, and this is different from the active ingredient field. For generics, the field is the same as the drug name, for brands it is usually different.

The manufacturer field is more specific to the IMS and FDB. This field could also be called the marketer field because in IMS and FDB it is used for whichever entity sells the drug and not necessarily the company that made the drug. In FDA terms, the manufacturer field relates to the entity that owns the patent and has nothing to do with the party that sells the drug. Typically, the manufacturer's name is listed in the manufacturer field but occasionally the marketer of the drug is not the same company that makes the drug, and the patent holder can be a different entity as well. The field is titled as manufacturer across all of the datasets in describing the present invention for ease of use.

There are several ways to merge the data sets from the various sources. One way could use the NDC number from the third party data to join directly to the NDC directory's NDC field for joining the EOB and Drugs@FDA data by the APPL_NO/NDA number (application number). Such a method would not work. The NDC number from The NDC Directory is not eleven digits long and no matches would occur as the 3^{rd} party data has eleven digit NDC numbers. The FDA explains the construct of the NDC directory's numbering system (http://www.fda.gov/Drugs/InformationOnDrugs/ucm142438.htm): “Each listed drug product is assigned a unique 10-digit, 3-segment number. This number, known as the NDC, identifies the labeler, product, and trade package size. The first segment, the labeler code, is assigned by the FDA. A labeler is any firm that manufactures (including repackers or relabelers), or distributes (under its own name) the drug. The second segment, the product code, identifies a specific strength, dosage form, and formulation of a drug for a particular firm. Different formulations or different strengths of the same formulation should be assigned different product codes. This means even if the same formulations of a drug product ultimately deliver different strengths of the active ingredient to the recipient, they should be assigned different product codes. Also, drug products that share the same formulation but have different product characteristics that clearly distinguish one drug product version from another cannot share the same product code under the same labeler code. The third segment, the package code, identifies package sizes and types. Different package codes only differentiate between different quantitative and qualitative attributes of the product packaging. Both the product and package codes are assigned by the firm. The NDC will be in one of the following configurations: 4-4-2, 5-3-2, or 5-4-1.”

To merely incorporate the raw NDC data into a database with the FDB or IMS data would result in total dropouts in the joining of the datasets because of the nonconformity of the NDC construct. Accordingly, this would cause an incomplete picture of the data. As explained in detail below, the present invention corrects the data joining process to fix the nonconforming construct of the NDC data. The present invention can even join drug data for any drugs that change manufactures, which occurs frequently. Normally, keeping the desired data history for a drug across the manufacturer transfer is desirable for competitive analysis, but it is very problematic to do so with the current systems because when the manufacturer changes, the labeler code portion of the NDC changes to the new manufacturer, and since the labeler code comprises the first five digits of the NDC number, the change in the labeler code changes the code of the drug.

The preferred methods to merge the data from the datasets described above are summarized in the steps listed below. The present invention attempts to join the data by the following passes through the datasets (first, the EOB data is joined):
1. NDC (only the 1st nine digits, the package code is not needed for this join).
2. Trade Name, for branded products only since the name is a trademark.
3. Trade Name from the IMS/FDB data again with the labeler code (1st five digits of the NDC) for all manufactures. This join affects generic drugs since they are named for their pharmaceutical ingredient (e.g. all Toprol generics must be called metoprolol). It may not be satisfactory to use the Trade Name and the manufacturer name because each data set may name the same manufacturer differently (e.g. Teva Pharma vs. Teva Pharmaceuticals). This part of the join is multi-staged. First, a list of all manufacturers and all their associated labeler codes is generated from the list of IMS/FDB drugs. For each trade name, each possible labeler code is used in the join. The labeler code and the trade name are joined to the NDC directory.
4. Trade Name as before but the spelling from the NDC directory and the labeler code.
5. Active Ingredient Name with the labeler code. This is necessary because the data sets may abbreviate part of the spelling of the Trade Name.
6. Ingredient Name with the labeler code as before but spelling from the NDC directory.
7. Digit correction in the NDC Directory for the Labeler code. The EDIS software must ensure the Labeler code is five digits long, the Product Code is four digits long and the Package code is two digits long. An extra ‘0’ is needed at the left most character position to ensure each code is its correct length. Depending on how the NDC Directory stores the entire NDC code; the Labeler code or the Product Code or the Package Code might need an extra ‘0’, EDIS is able to determine this by the length of each part of the NDC in relation to the ‘-’ stored in the NDC field.

By using steps 3-6, most drugs can be correlated across the various datasets even if they that change manufacturers. Otherwise, the datasets can be merged merely by using steps 1 and 7. After merging the EOB datasets into the EDIS database, the system then repeats the process with the Drugs@FDA dataset file.

The NDC numbering system has eleven (11) placeholders (NDC=12345-6789-01) with the first five (5) placeholders being a unique code for the manufacturer (12345=labeler code corresponds to a manufacturer). The next set of placeholders in the NDC number are for a product at a particular dosage that is produced by this manufacturer (6789=product code, such as Lipitor 10 mg, but Lipitor 5 mg would have a different number). The final set of placeholders in the NDC number are for the package (01=package code, box of 30, a Lipitor 10 mg box of 100 would have the same labeler and product codes but a different package code).

Once all of the datasets are merged, the EDIS database has all NDCs/SKUs and their related patent data, approval data and exclusivity data (regulatory/patent information). Some products have multiple approval dates, such as when a manufacturer adds a new strength or dosage. This would cause a product to have multiple records, as shown in the table below.

| Product | NDC | Label | Approval | Approval | Excl. | Pat. Exp. |
|---|---|---|---|---|---|---|
| Toprol XL | 12345-6789-01 | Toprol XL 5 mg | 123456 | 1/1/1995 | 1/1/2005 | 1/1/2002 |
| Toprol XL | 12345-6789-02 | Toprol XL 10 mg | 234567 | 1/1/2000 | 1/1/2010 | 1/1/2007 |

For an individual product, such as Toprol XL, the system of the present invention rolls up the NDCs to the product level and takes the minimum approval date, maximum exclusivity date and maximum patent date to display FDA information at the product level. The other dates are still in the EDIS database and can be looked up. Accordingly, when a rolled-up product is displayed at the product level, such as Toprol XL, a summary of the information is provided, such as shown in the table below.

| | Min | Max | Max Patent |
|---|---|---|---|
| Product | Approval Date | Exclusivity Date | Expire Date |
| Toprol XL | Jan. 1, 1995 | Jan. 1, 2010 | Jan. 1, 2007 |

Another example of a product roll up is illustrated in FIG. 3B. The brand product family Accuneb has two (2) different products (NDCs) and GCNs. By converting the PROD_NAME to product family, the EDIS software associates all the Accuneb NDCs with one record of Accuneb. This allows the EDIS software to calculate sales totals for the overall product family. The GCNs match the generic products made by Watson and Nephron. Accordingly, in this example, Accuneb has two (2) competitors.

Whenever the system in the present invention receives updated data from a data provider, the system triggers several processes to organize the data. The steps listed below define particular calculations performed by the system.

First, the ‘Product Families’ are created by altering the IMS field PRODUCT NAME by stripping out an IMS code that identifies the manufacturer and the date of first sale (e.g., IMS field ex “DARVON XAN 66/03” becomes “DARVON”).

The original manufacturer is then saved as well as the date of first sale (e.g., 03/1966, continuing with the use of DARVON as an example). Because generics are only referred to by their active pharmaceutical ingredient, an additional field FAM_MFG is created to distinguish between generic product families. A DIGOXIN example is shown in the table below.

| PRODUCT_FAM | MFG | FAM_MFG |
|---|---|---|
| DIGOXIN | WEST WARD | DIGOXIN_WEST WARD |
| DIGOXIN | LANNETT | DIGOXIN_LANNETT |

The current date for the dataset is established and Moving Annual Totals (MAT) are calculated for sales dollars and units. The MAT values are calculated from monthly data that is segregated by sales channels (retail, distributor, hospitals, etc.).

The main tables holding the FDB and IMS datasets are constructed (listed below).
DRUG_MART_IMS_DRUGS_MAT_MVW
DRUG_MART_FDB_DRUGS_VW
DRUG_MART_FDB_PRICE_VW

The EDIS dataset merging methodology creates a list of valid NDC records by joining the FDB and IMS datasets by the NDC numbers (table heading DRUG_MART_FDB_IMS_NDC_GCN_VW). Only matches are considered valid records (“Good Drugs”). All matches from the FDA data to the EDIS database are made to the ‘Good Drugs’ list. If the EDIS software does not get a match, the drug does not exist in the database. This can sometimes happen when a NDC gets updated. For example, a manufacturer may notify FDB of the update before IMS or visa-versa. In the next month's data update, the inconsistency between the datasets gets resolved, and the information for company may miss a drug for a month, but this would be a rare occurrence.

After the EDIS software creates the base tables, the EDIS software then creates the tables that get displayed in the forms. The tables that reference competitors (Competition tables) are built using the Generic Code Number (GCN) that FDB provides by the corresponding NDC number. Each drug is assigned a GCN by FDB, and when drugs have a matching GCN, it is an indication that the drugs are substitutable for each other. The EDIS software creates a summary of manufacturers in which all sales for each manufacturer are summed (MAT), and the total products are counted (table heading DRUG_MART_APP_FIRMS_MAIN_VW). The EDIS software also creates summaries of product families, including market information and regulatory/patent information. For the market information of each product family, MAT sales are summed, competitors are counted, and sales for competitors and current product family are summed in MAT fashion (table heading APP_PROD_COMP_tbl). For the regulatory/patent information of each product family, the summary of patent, exclusivity and approval dates are created as described above. This information also incorporates FDA data updates (table heading APP_PRODUCT_DATES_tbl). The EDIS software also creates a summary of brand/generic combinations which is a monthly accounting with units and sales for both the brand and generic (table heading mbg_detail).

The EDIS software also uses other tables for the analytical processing of the data records. FIG. 3C is a data diagram that shows how user entered product tracking takes place. The evaluation data and user entered potential patents are listed in the diagram. The forecast header is linked in with all product development costs, royalty information and competition data. FIG. 3C shows the data flow for the forecast templates. Generally, the data diagrams shown in FIGS. 3C and 3D illustrate how the user entered data is organized within the EDIS database.

The merging of the datasets in this manner results in the aggregation of the sales/unit/pricing data along with all competitors for pharmaceutical compounds and the regulatory/patent data in a single database. The aggregated database allows users to more efficiently examine the data than they could possibly do when the datasets were apart in their own individual databases. The aggregated database allows the users to display the merged pharmaceutical records together and filter the merged pharmaceutical records according to one data element that comes from one set of pharmaceutical records and also according to another data element that comes from another set of pharmaceutical records.

Also, by using the GCN from FDB, all substitutable products are listed with sales data and share information. Accordingly, as discussed in the data analysis section below, the EDIS merged database also leverages the GCN join to make data mining of previous generic to brand introductions possible for a point and click forecast. Most current forecasting applications and/or templates follow assumed rules, and the user must have a detailed level of understanding of those rules and assumptions to complete a forecast. Also, to use current forecasting techniques, the user must manually obtain and enter all the data necessary for a forecast. The EDIS software allows users to pick another company's previously launched generic for the product of interest and use that generic launch as template for forecasting of another pharmaceutical compound. With the EDIS software, analysts can insert their product for another and still have the ability to edit future events.

Integration of the Clinical Trials (CT) data occurs by joining the list of ‘good drugs’ by either the Product Family Name or the Generic Name to the Intervention field of the Clinical Trials data. Additionally, EDIS joins the manufacturer to the CT data's Sponsor field. The CT data is displayed in various ways. First, the user of EDIS can query the data directly, next for each Product Family and Manufacturer, EDIS displays the number matches in the CT data for a specified time period (in days) and all of time. For example, say in the past 30 days seven different manufacturers have started seven distinct trials for a generic version of Pfizer's Lipitor. If the user is viewing Product Family data for Lipitor and specifies a 30-day time horizon for the CT data, EDIS would return seven new entries. The all of time value would be something higher than seven because the original branded drug would be required to have entries in the CT data. The Clinical Trials data is downloaded from the ClinicalTrials.gov web site daily and EDIS does not alter the data in any way and makes every attempt to match the data on the CT web site. The query used for the extract is Intervention=Drug. EDIS organizes the downloaded data file into five tables as seen below. EDIS does not extract the entire CT database; it limits the data to basic fields that can give the user an understanding of the trial. This includes the Phase, Intervention, Sponsor, Condition, Title of the trial, Start Date, Completion Date, Last Updated Date and the hyperlink to the trial.

Once all of the datasets are correlated, updated and merged into the EDIS database, the analytical tools operated by the computer processor can operate on the merged datasets.

### Data Analysis

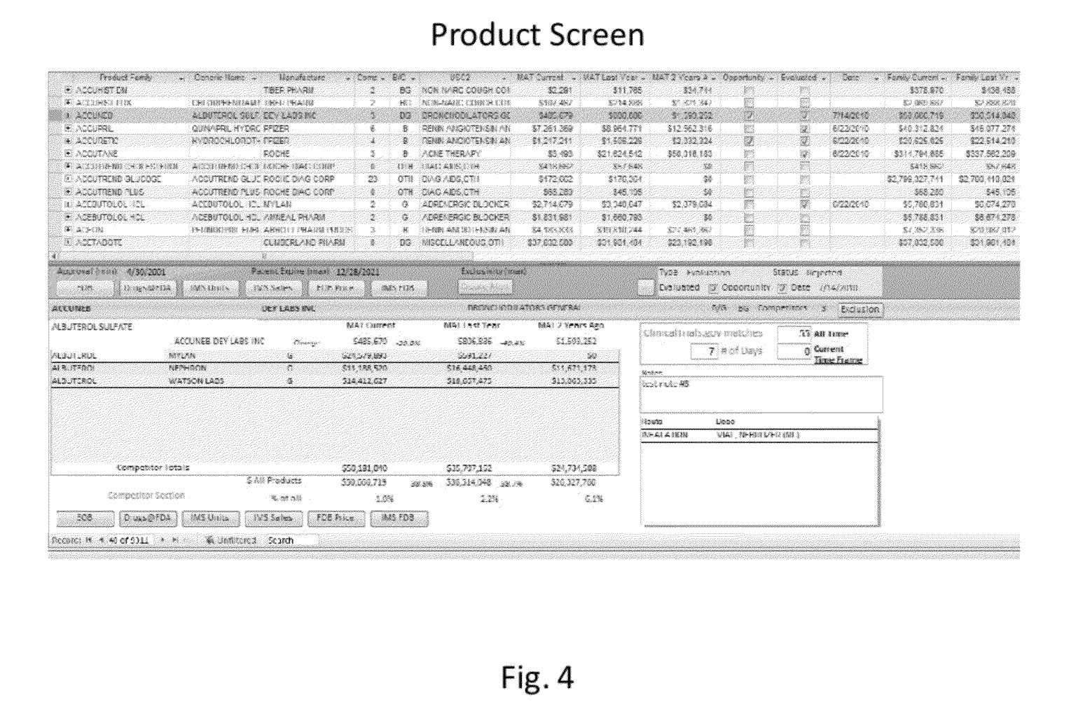

The product screen shown in FIG. 4 is helpful for data mining. This screen lists every drug from IMS and First Data Bank that match by the NDC number. The pharmaceutical compounds listed on this screen include the valid records (i.e., good drugs) that are available in the merged datasets. The listing includes the product, manufacturer, brand/generic designation, number of competitors, USC code, Moving Annual Total (MAT) current sales, MAT from last year, MAT from two (2) years ago, user entered fields of opportunity, evaluated and date evaluated, MAT sales for the entire product family (current drug plus all competitors) for current year, last year and two (2) years ago, the first date the product was approved, the last exclusivity date, the last patent expiration date and the number of CT trials for the product.

If the product has no competitors then the MAT current will equal the Family MAT current sales. Conversely, if the product has competitors, the MAT current will be lower than the MAT family because the MAT family will include the MAT current sales for the product being reviewed plus the MAT current sales for the competitors. As discussed above, the EDIS software calculates the MAT sales for all products and links substitutable products by GCN to identify the competitors for each product. The EDIS software sums up all the sales to get the MAT current for a product family. As a comparison of the EDIS software and the individual, isolated products available before the present invention, the FDB software that holds the GCN is able to display a listing of competitors but only at the NDC level; the FDB software does not total up the number of competitors nor does it give a sales figure for the size of the total market. To get the number of total competitors out of FDB, an analyst would need to look up every NDC for a product and manually total the competitors making sure not to double count any of them.

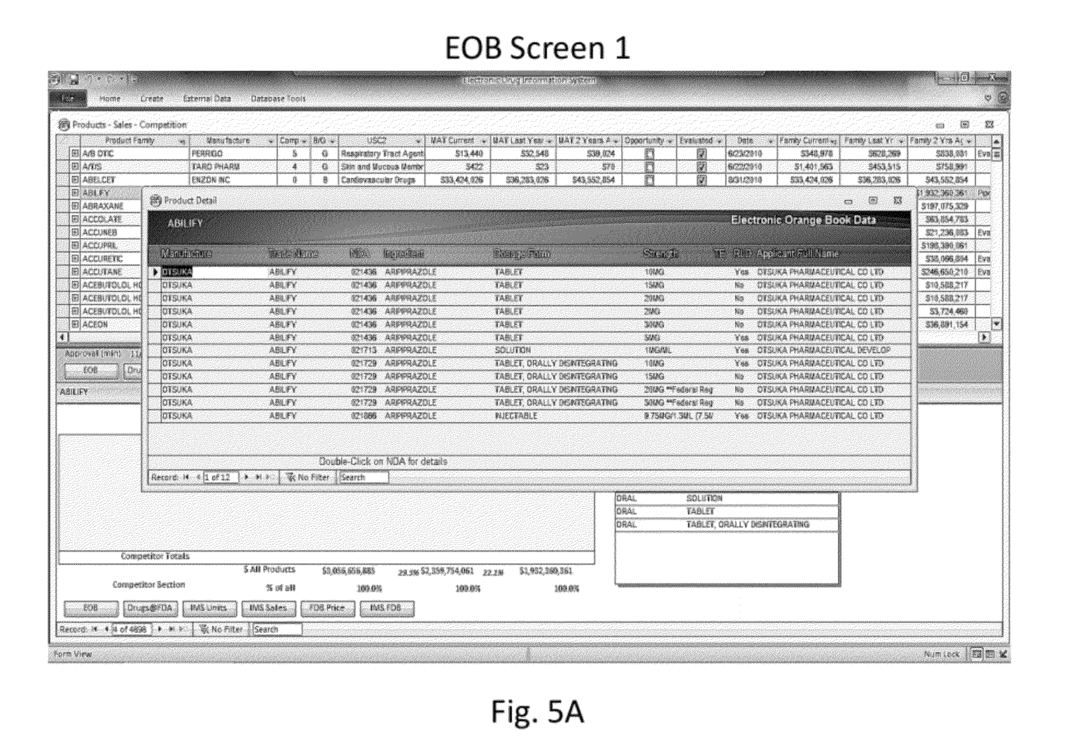

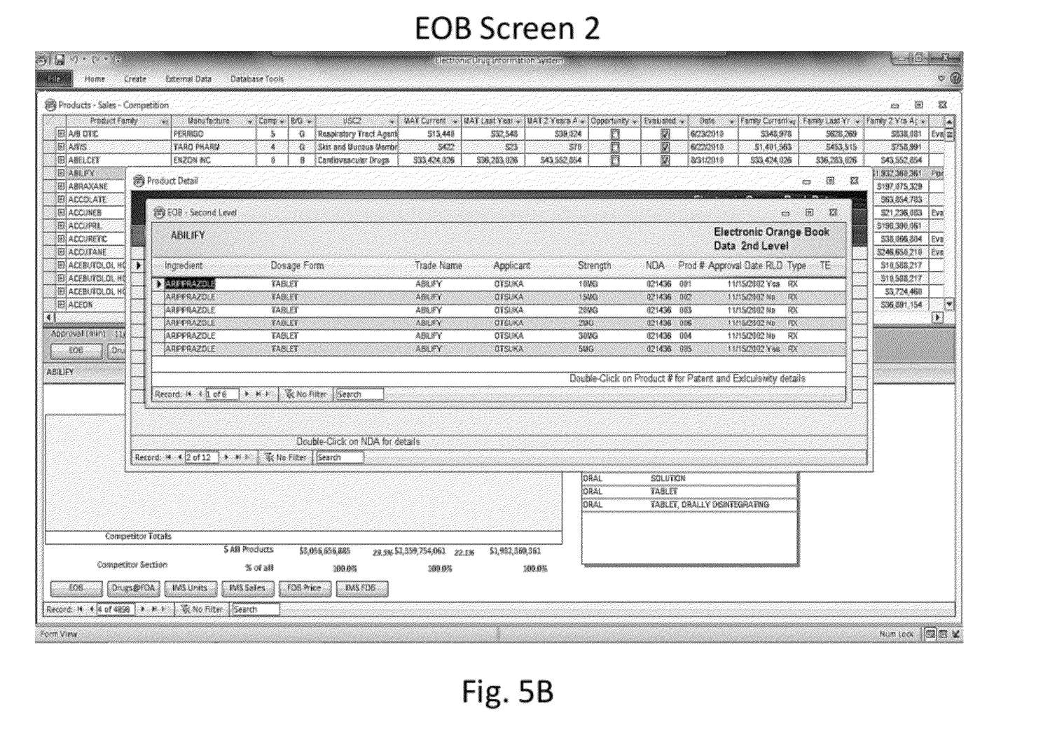

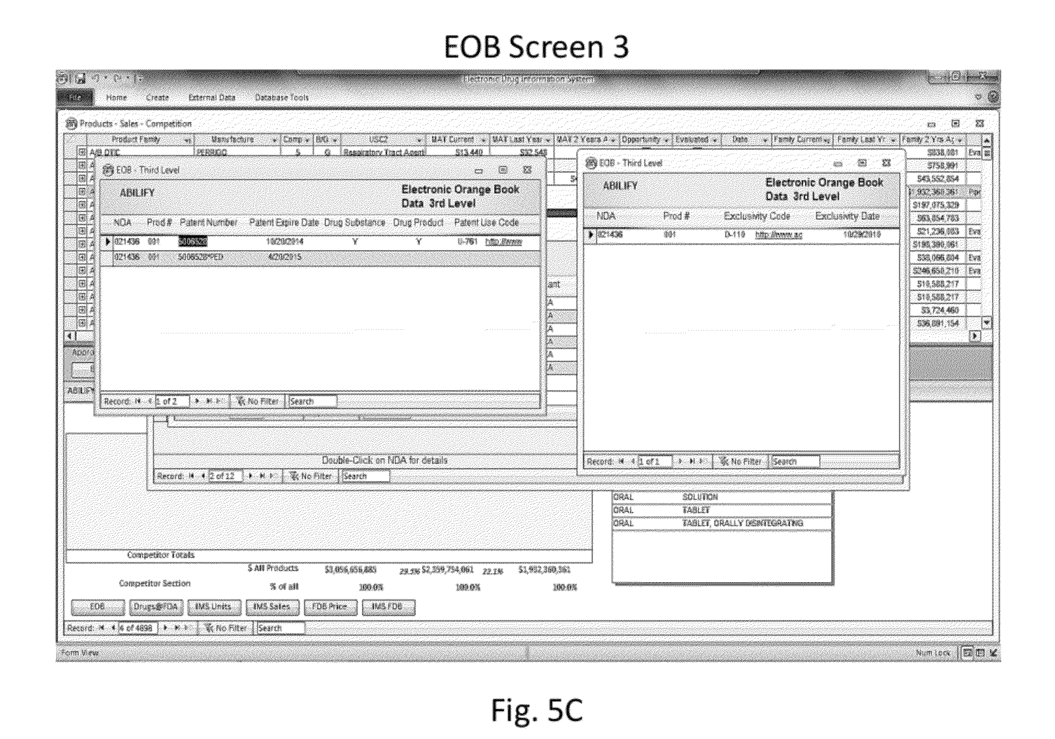

A unique feature of the EDIS software is that it links the FDA data in its merged database. This permits a user to select a drug and go into the Electronic Orange Book (EOB) data within the EDIS software environment. Examples of the EOB screens available through the EDIS software are shown in FIGS. 5A, 5B and 5C. Accordingly, this screen shows the IMS, FDB and FDA data as it is merged into the EDIS database and can be manipulated by the EDIS software through queries, parsing and filtering of the merged records.

Using the merging methodology described above, the present invention's linking of its list of “good drugs” with valid NDC numbers to the FDA data is unique and maximizes the joins to the FDA data. Even though the data is not easy to link, the present invention first pass at joining the data is based on the brand name, because if the pharmaceutical compound is a brand name drug, then the name is a trademark which makes the spelling the same regardless of the data source that is being used. The generic drugs get more complicated because all generics are named after their active ingredient. Therefore, in order to find the approvals for generic drugs, the name will get matches for all manufacturers of the product, but it is important to match the approval for the generic manufactured by each particular manufacturer. The manufacturer name cannot be used because of the differences in spelling of the names (Inc vs. Inc. or Teva Pharma vs. Teva Pharmaceuticals). The details of the FDA joins are discussed in detail above.

Before the present invention, analysts must manipulate the individual data records as they are isolated in separate software packages. In current systems, there is no attempt to integrate the data because it is too hard to do without the present invention. Without the present invention, to integrate all the information on this screen, an analyst needs to look up the data they want in IMS, then look up the corresponding data in FDB and then obtain the corresponding FDA data. The analyst would have to manually combine all of the data in a dataset for yet another program because none of the software programs for the IMS, FDB or FDA data allow a user to view all of the data together, and certainly none of these systems allow a user to perform the analyses of the present invention on the merged data records. In order for an analyst to quickly check which drugs are being investigated for potential new generics or new versions of a branded drug, hours would be needed to either review all new entries at the Clinical Trials web site and then summarize by the intervention, or the analyst would need to look up many drugs individually. In EDIS, the user simply needs to select a time period for CT activity and sort the data by the current CT time frame data field to get the list of drugs currently starting trials. The present invention uniquely permits users to view all the data on one screen, sales, competitors, competitor sales and approvals, patent expire, exclusivity dates and clinical trials.

Additionally, EDIS allows people to quickly mine the data in ways not easily possible by keeping the data separate. It would take a lot of manual work to reproduce this screen for all of the pharmaceutical data records that are available, and by the time it was done manually, the data would be old and out of date. By filtering and parsing the combined data records, the EDIS software makes it possible to efficiently identify and obtain the data that meets particularly specified criteria. For example, in a matter of seconds, a user can select the filters in the EDIS software's product screen to retrieve all of the pharmaceutical records which meet the following criteria: markets that already have generics and that have over $100M in annual sales with less than three (3) competitors and no more patents in force. To determine which pharmaceutical records may match this set of criteria in the traditional manual approach, without EDIS, an analyst would need to perform the time-consuming and error-prone tasks listed below:
1. In FDB, the analyst creates a listing by GCN of all brand/generic product combinations. First, pull all brand GCNs and put this in Excel or a database. Next, pull the same data for all generics. Next, find all matching GCNs between the two datasets. This is done at the NDC/SKU level, so the analyst would need a way to roll the data up to the product level to count the number of competitors. For example, Toprol XL (brand) has 4 SKUs. Each SKU has a unique GCN that matches the SKUs from generic manufactures. The first GCN matches generic manufacturer A, B, C. The second GCN matches A, B, C, and D. The third GCN matches A, C and D. The fourth GCN matches A, B, C, and E. Therefore, Toprol would have fourteen (14) matches overall, but it has only five (5) unique competitors. To roll this up in Excel would be time consuming and prone to errors, and a database would almost be required at this point because there would be thousands of combinations. Once the analyst has the total number of competitors for all brand/generic combinations at the product level, the analyst can remove all combinations which have more than three (3) competitors.
2. Now in IMS, the analyst looks up all the MAT sales for the products in the list. This list would be very large and very time consuming as each product is looked up individually. Next, match up the sales with each product and sum up each brand/generic combination and exclude those that aren't greater than $100M.
3. With the products that remain, the analyst examines the Electronic Orange Book for each brand to determine whether any patents remain in force.

Following purely manual operations, it would take a team of analysts working for days just to produce a list based on this set on set of criteria, and with each calculation, the risk of error would increase. With the EDIS software, the task is completed in seconds. Accordingly, the product screen helps pharmaceutical manufacturers efficiently identify those markets which satisfy their search criteria and examine the markets for possible entry.

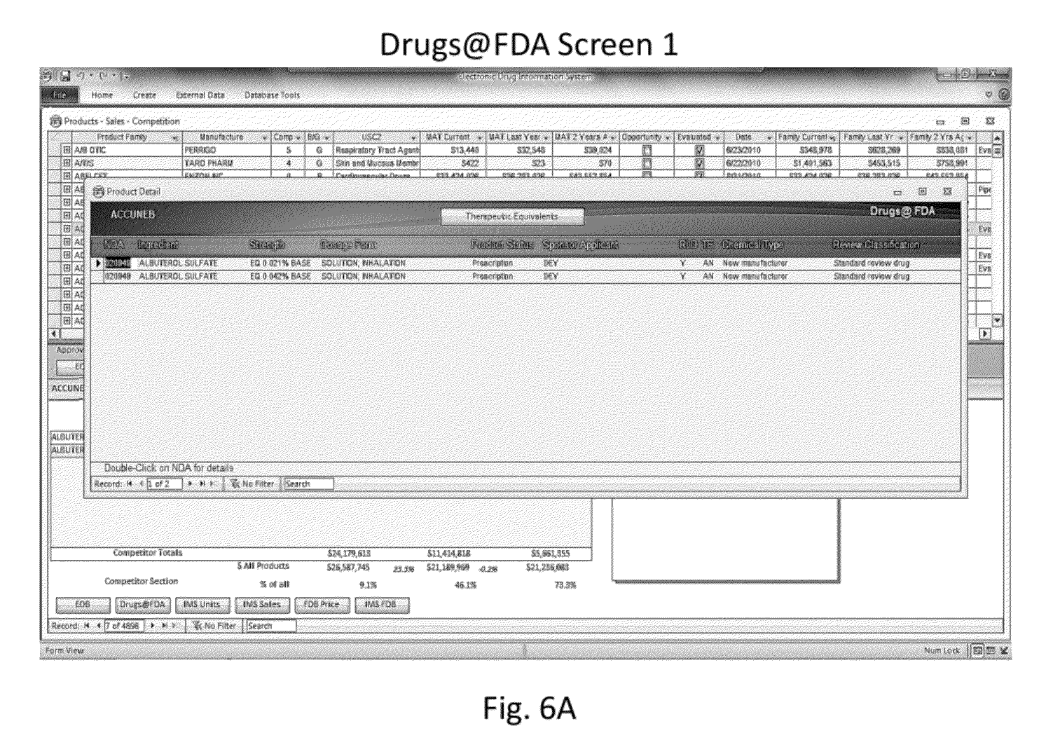

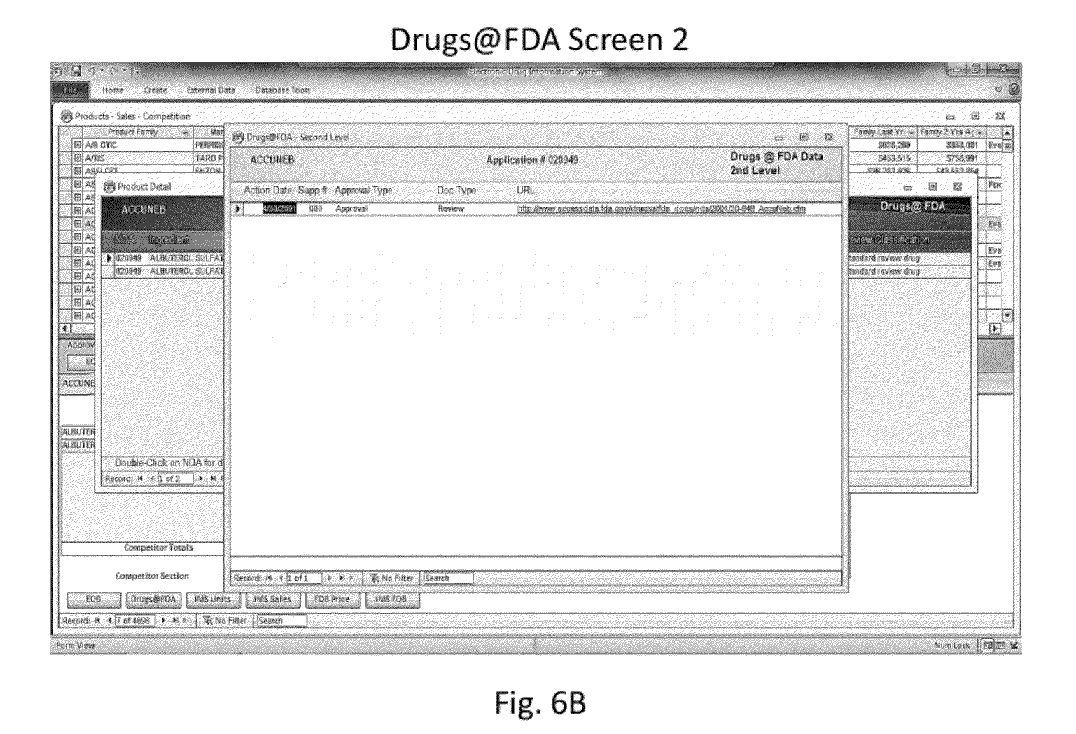

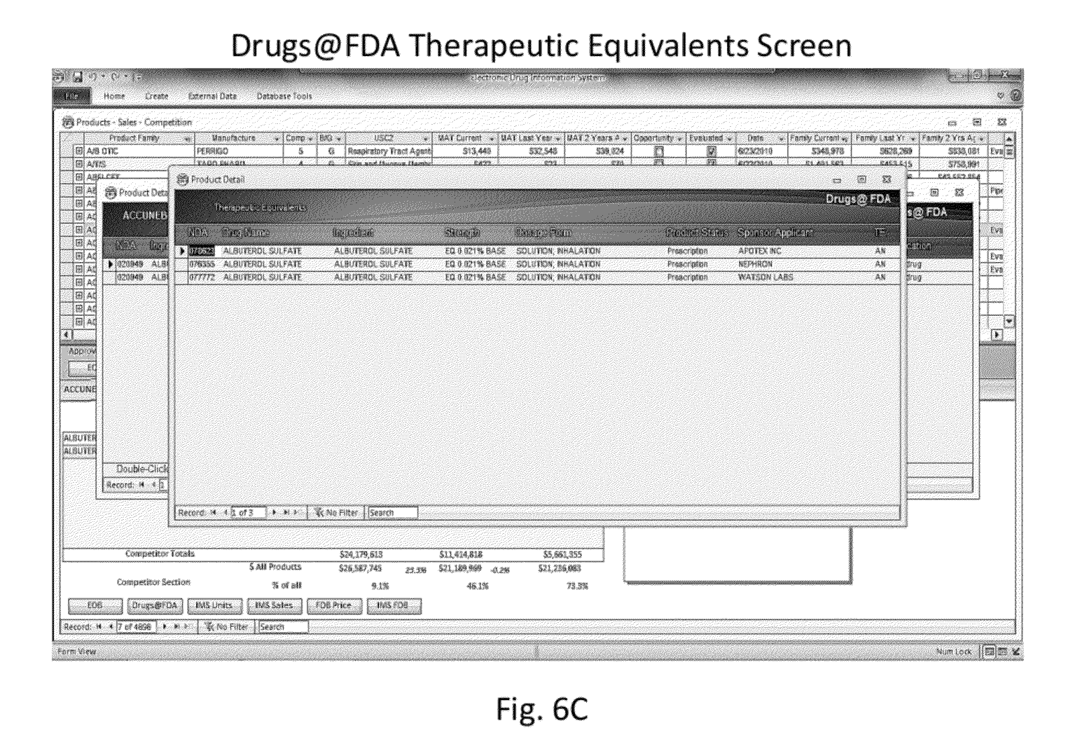

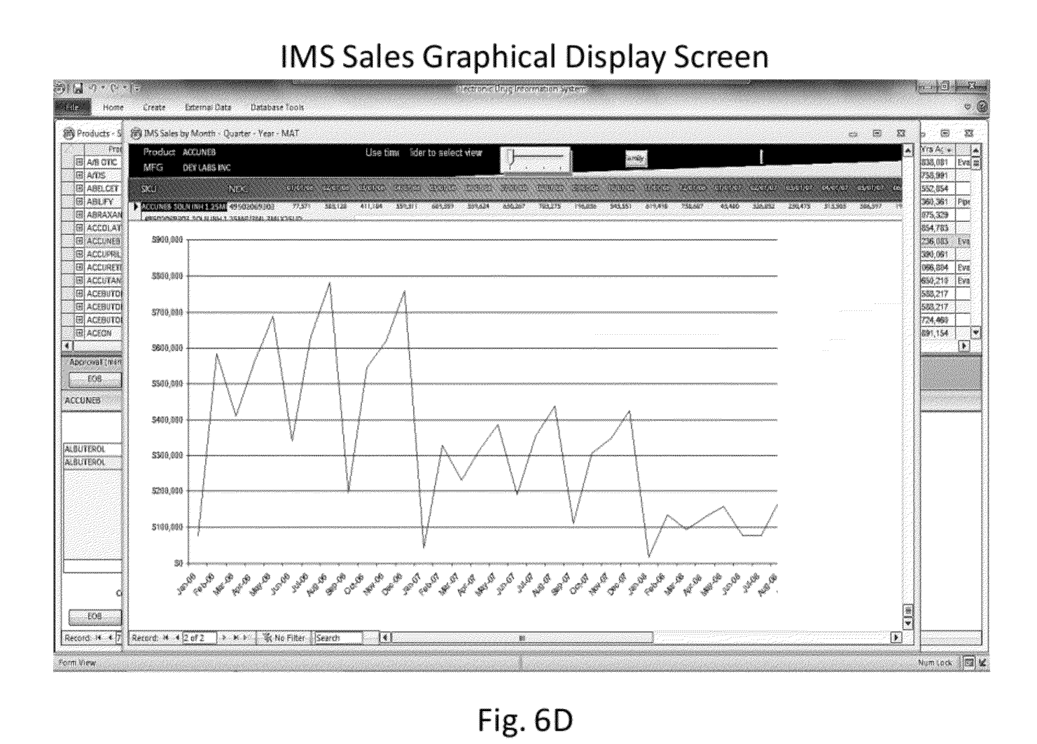

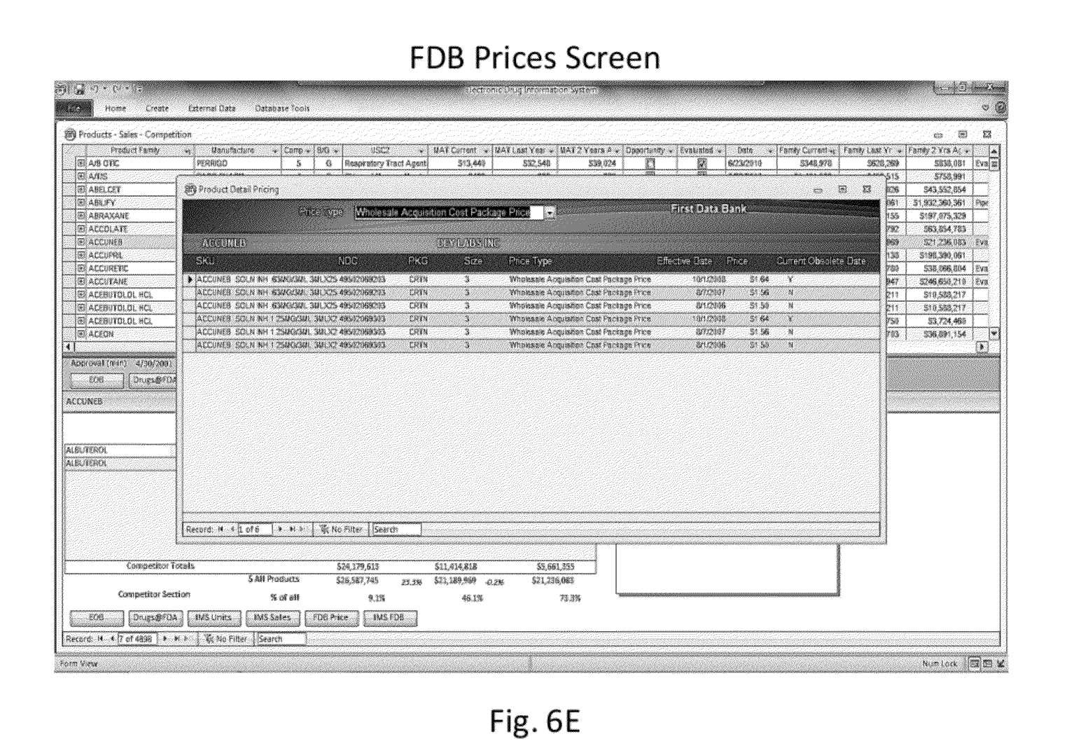

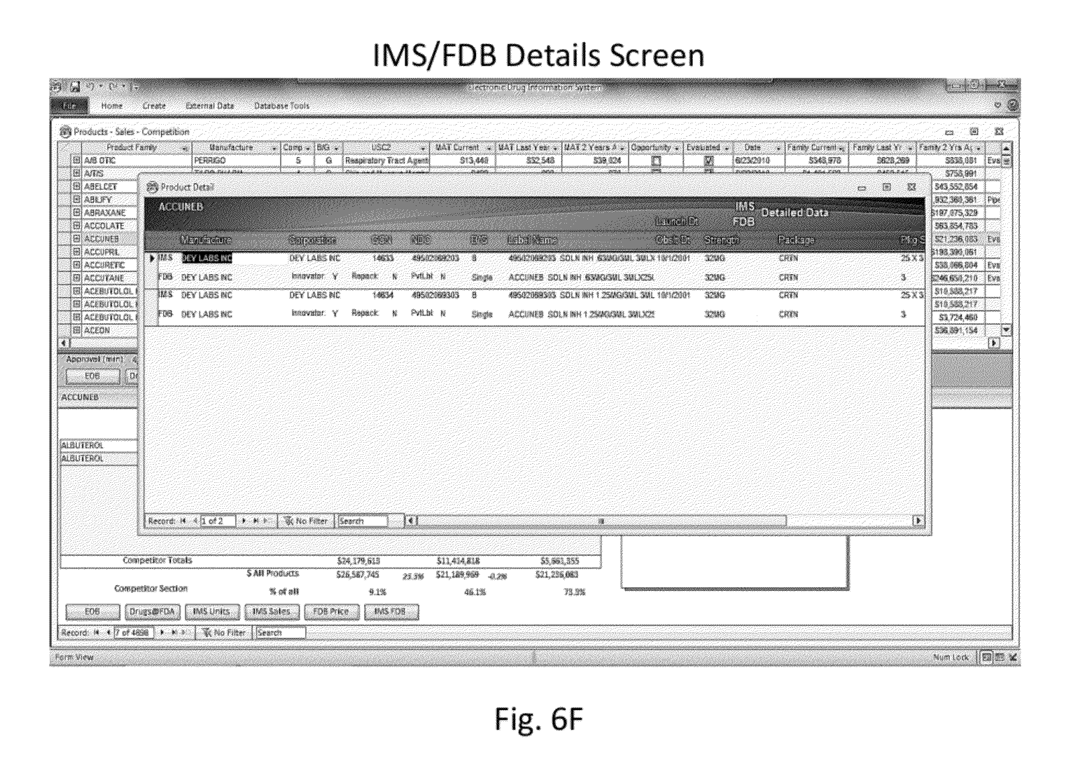

The screens displayed by the EDIS software can minor what the FDA uses on the websites for the Electronic Orange Book and Drugs@FDA. Examples of the versions of the Drugs@FDA screens which are available using the EDIS software are shown in FIGS. 6A, 6B and 6C. The EDIS software can also be used to chart and display the IMS sales and unit data as shown in FIG. 6D. A user can also pull up all FDB pricing as shown in FIG. 6E and the detail product information from IMS & FDB about the units as shown in FIG. 6F.

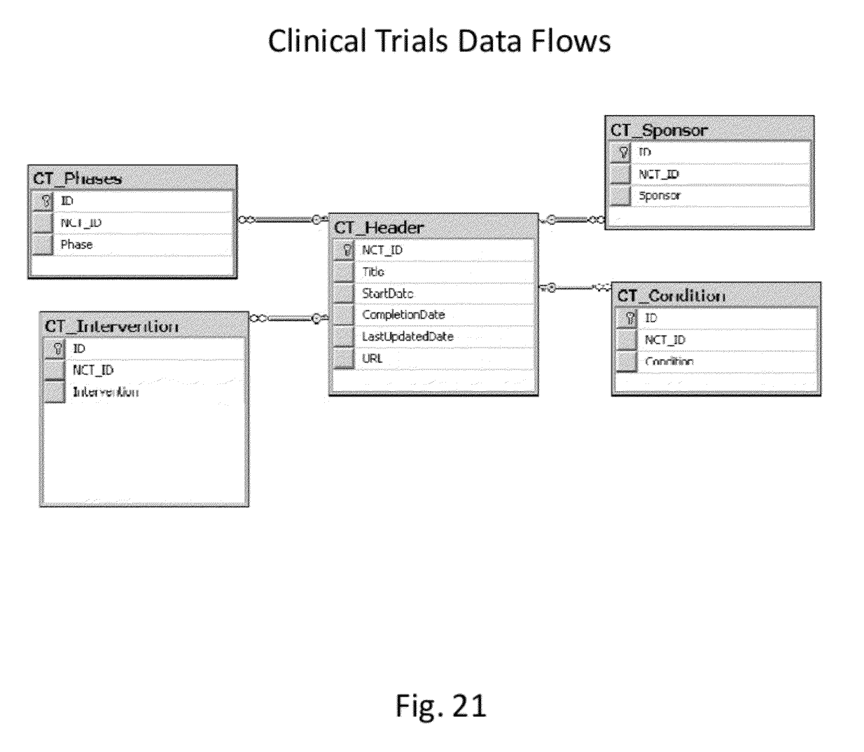

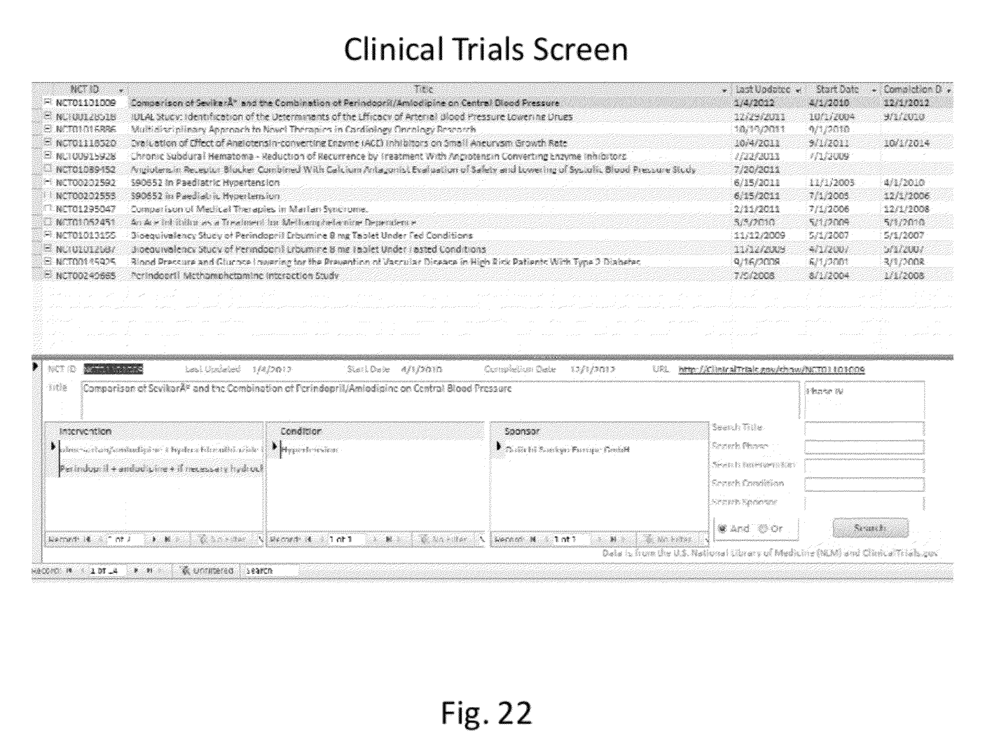

By clicking on either of the CT time frame labels, the user displays the relevant CT data for the product, as shown in FIGS. 21 and 22. These screens are identical to the full data search of the CT data. By entering the CT screen from the Product Screen the data is filtered to just the product and time frame in question. The user can search these results further by using the search fields and if more information on the trial is needed, each trials hyperlink is provided to view the trial on the clinical trials web site.

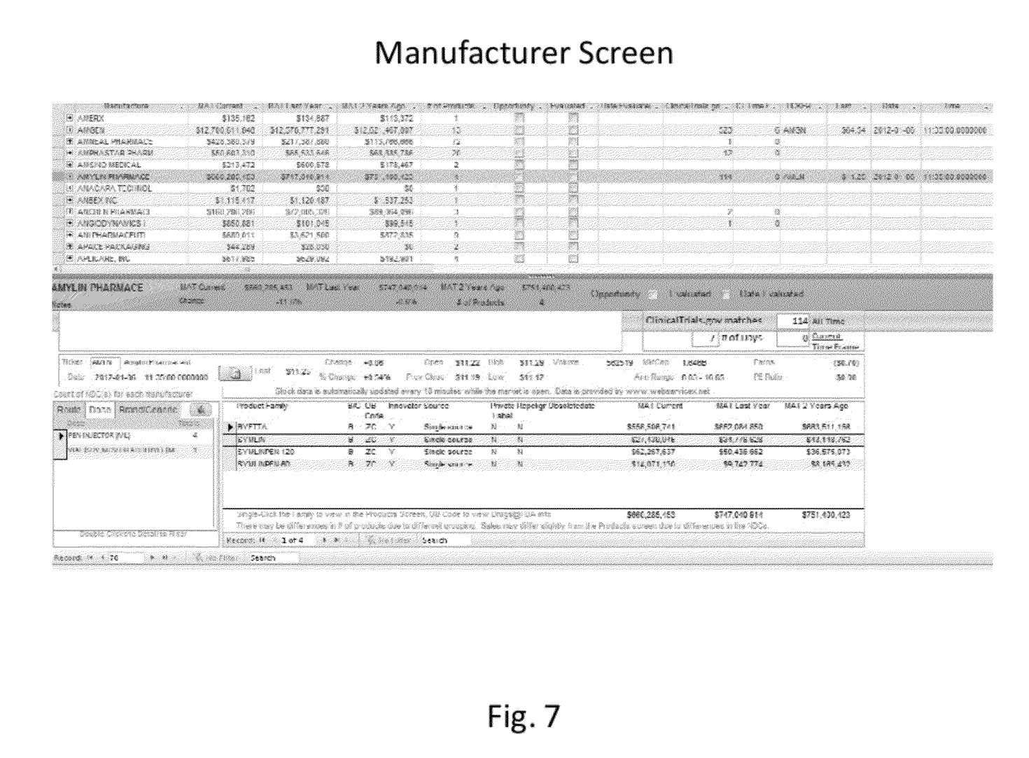

The merged data records can also be displayed according to the various manufacturers. The manufacturer screen, shown in FIG. 7, is another slice of the same data that is available through the product screen. The EDIS software links elements that are displayed on the manufacturer screen back to the product screen. The CT data is presented in the same fashion as the product screen however the link to the CT data has changed to the Sponsor of the study to the manufacturer of the EDIS data. Stock data is provided on this screen. EDIS HUB updates the quotes every ten minutes from a web service (www.webservicex.net) for stock tickers provided by the user. The data returned includes the last price, change in percent and absolute, the opening price, previous close, high and low price for the day, volume, market capitalization, annual price trading range, earnings per share and price to equity ratio. Each of these fields is sortable via the EDIS interface. The manufacturer screen also allows the user to investigate each manufacturer's abilities. Each NDC for each manufacturer is grouped into three different categories, Route, Dose and Brand/Generic. The user can then determine what type of product(s) the manufacturer specializes in and see the sales for each category by clicking the detail data of the form and the full product list will be filtered for the selection.

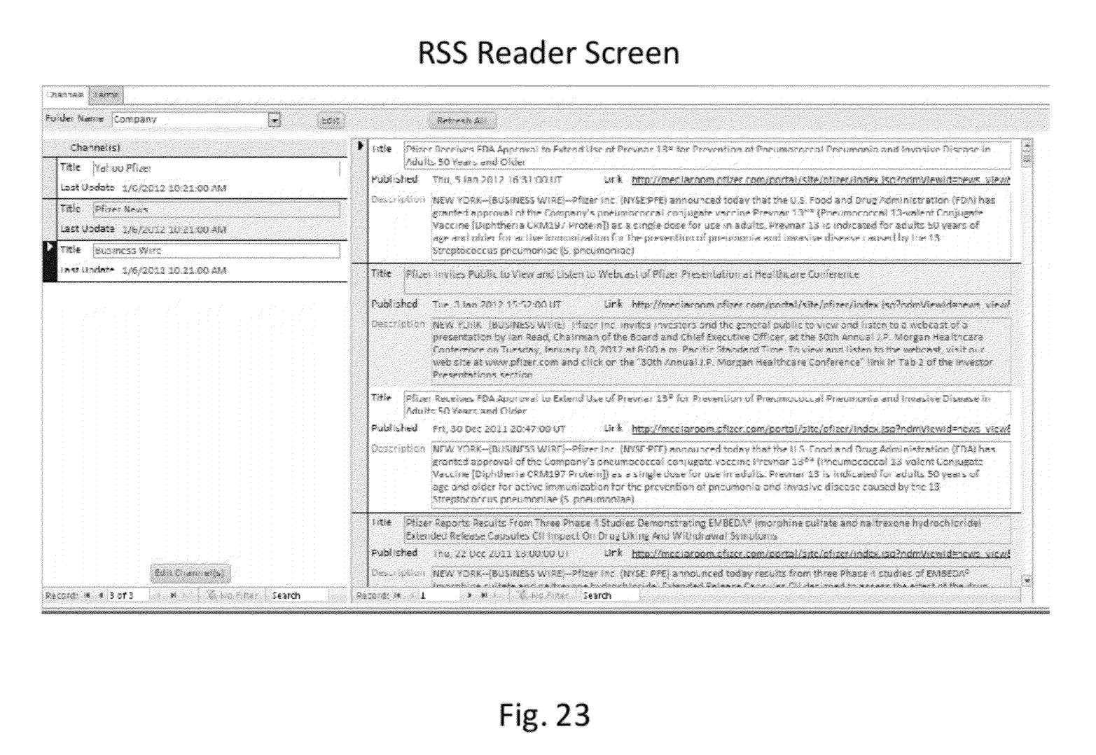

EDIS also provides the user with a RSS Reader, as shown in FIG. 23, to keep current on industry news. The user picks RSS Feeds that are relevant to complete their job and EDIS will pull the feeds automatically for them. Each feed is organized in a Channel and each Channel into overall folder. EDIS displays the title, publishing date, description of the feed and the hyperlink to view the article in a web browser. Each time EDIS is started, the RSS Feeds will update. The user can also update the feeds on demand.

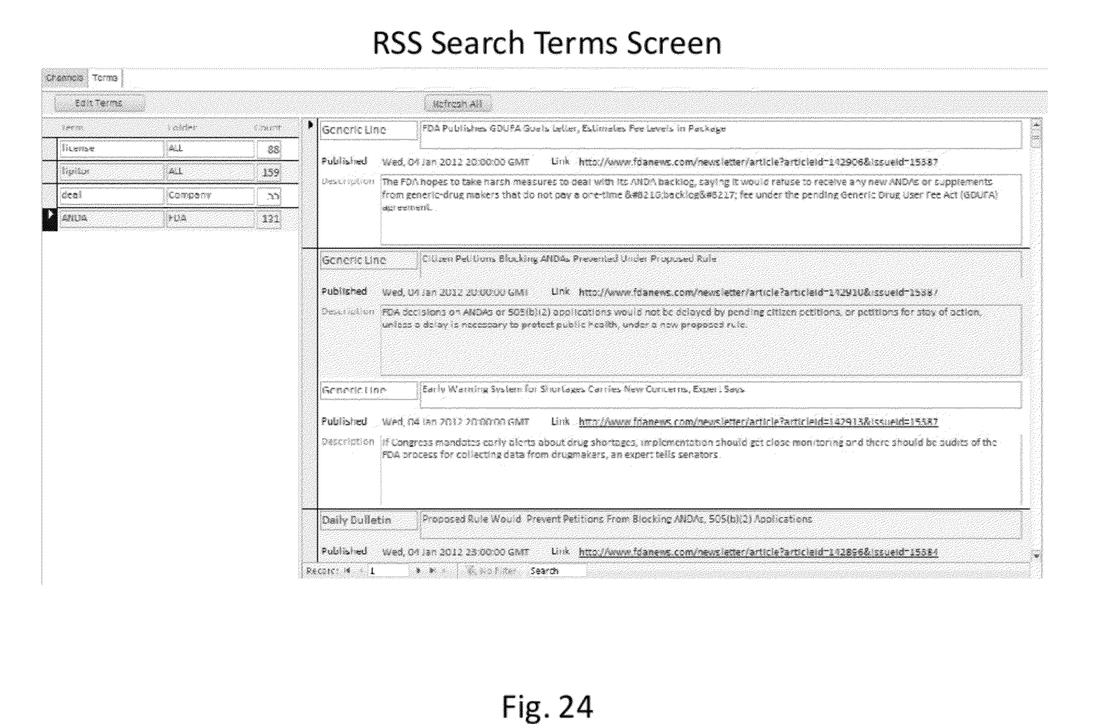

To make the feeds more than just a reader, the user can create search terms and pick the feeds for EDIS to search in, as shown in FIG. 24. EDIS will search for each term in the title and description fields. The Terms tab on the RSS Reader will then display the results, total number of matches, the feed name, title, publishing date, description of the feed and the hyperlink. The Terms then can be used in the Alerts screen.

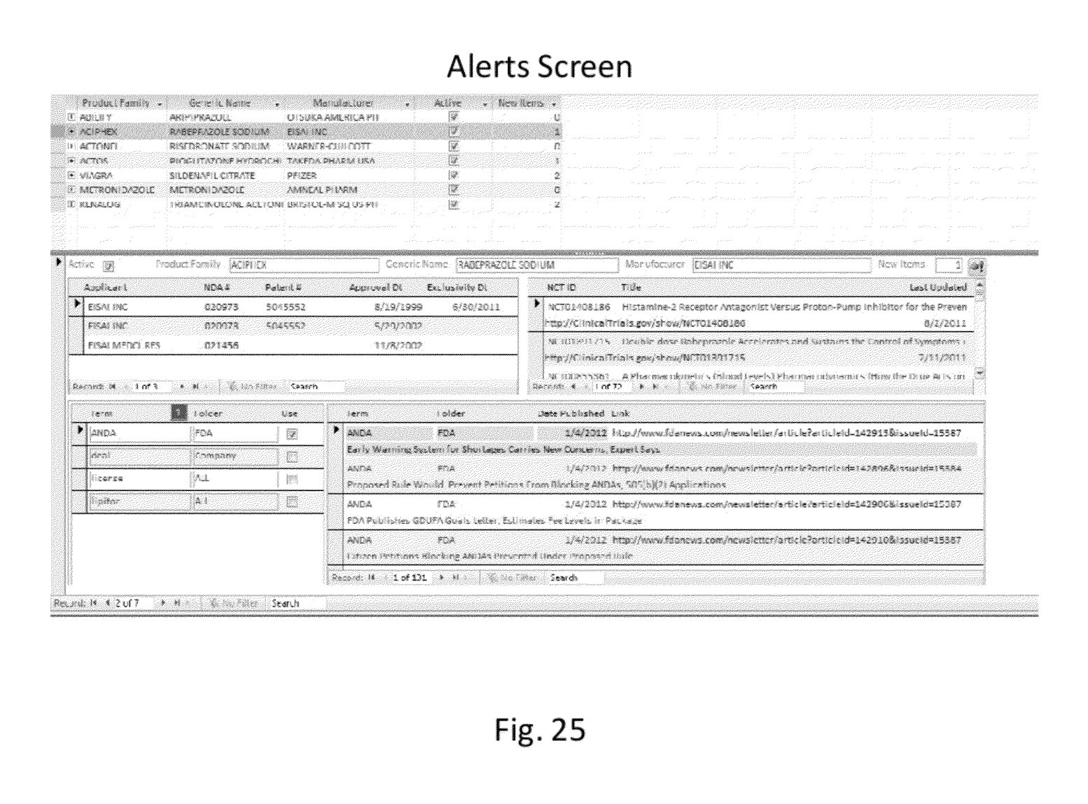

The Alerts screen on EDIS, as shown in FIG. 25, allows the user to stay on top of all activities related to products of interest. Because of all the data linkages, the user can get all the data relevant to product development in one place and with the alerts be the first person to know when anything changes in the industry. Alerts can be created on the Product Screen or on the Alerts screen. The product does not need to be in the database in order to receive alerts. On the Alert screen, the user enters a product name, generic name and manufacturer for the alert and EDIS will alert them when a new item hits the FDA's EOB or Drugs@FDA websites, a new trial has entered the clinical trials dataset and when a new RSS Feed is created matching one of their search terms. When EDIS is opened, it checks for new alerts for all categories and displays the number of new alerts on the main menu screen. To mark an alert as ‘read’ the user clicks on it to reduce the number of new alerts by one. The user can also view the alert by clicking on the hyperlink and EDIS will open the appropriate screen.

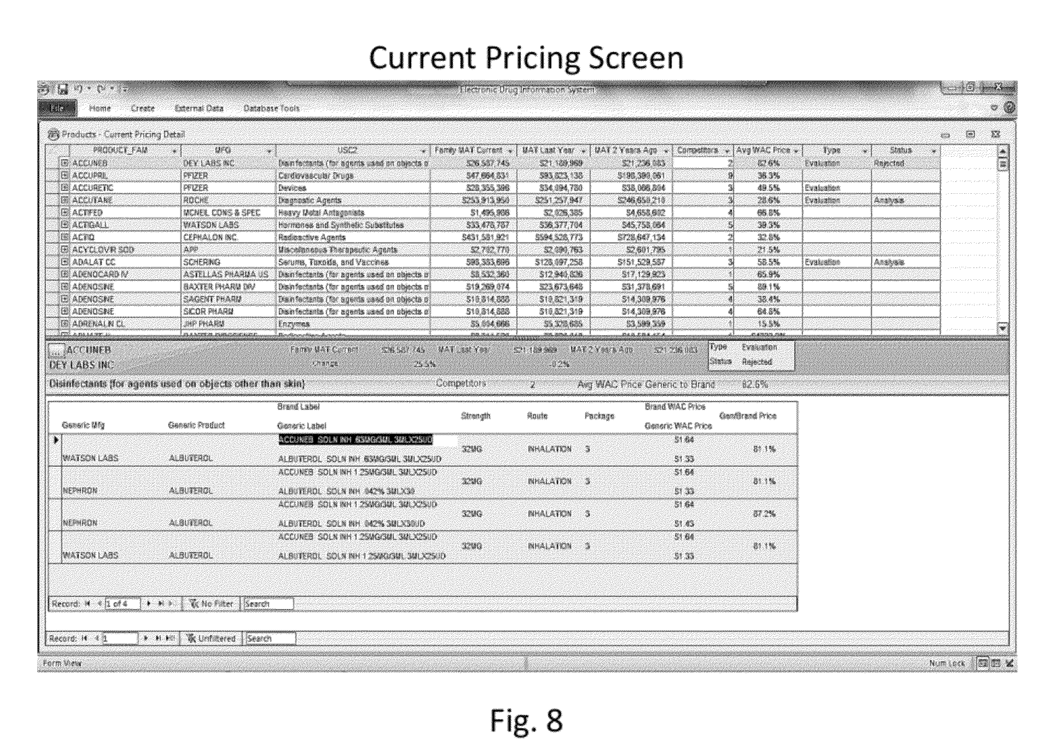

The EDIS software's current pricing screen, shown in FIG. 8, provides the user with a way to look at the pricing relationship (Wholesaler Average Cost or WAC price) between brands and their related generics, i.e., the product family. For each of the NDC records that match by the brand/generic combination (GCN), the EDIS software compares the relative pricing by dividing the brand price into the generic price to get the generics to brand WAC price ratio. If a manufacturer does not publish the WAC, the EDIS software uses IMS data to calculate a rolling three (3) month average of sales divided by units sold.

The screen displays the sales for the entire product family by the last three (3) years' MAT, number of total competitors, USC code, and the average generics to brand WAC percentage. When the generics to brand WAC price ratio has been calculated for all of the individual results for a particular NDC, the EDIS software takes an average to determine the generics to brand WAC percentage at the product family level. The bottom part of the screen shows the details for each GCN by SKU/NDC and the actual prices. As with the manufacturers screen, the EDIS software links elements displayed on the current pricing screen back to the product screen. Most of the data for the current pricing screen is the same as the product screen, with the addition of the pricing of individual drugs (NDC level).

Again, for an analyst to evaluate the data calculated by the EDIS software and displayed on this screen, a significant amount manual work would be required. In a matter of seconds, a user can select the filters in the EDIS software's current pricing screen and retrieve all of the pharmaceutical records which meet the following criteria: markets that have over $100M in sales, less than four (4) competitors and generic pricing that is close to 50% of a brand's WAC. Accordingly, the current pricing screen can be very helpful in screening for markets that a company may want to enter. The exercise for someone without the EDIS software would be very similar the manual approach described above, but the analyst would not need to examine the EOB. However, for every GCN, the analyst would need to look up the current price (same database FDB has pricing and GCNs), and the analyst would need to calculate the generics to brand WAC percentage.

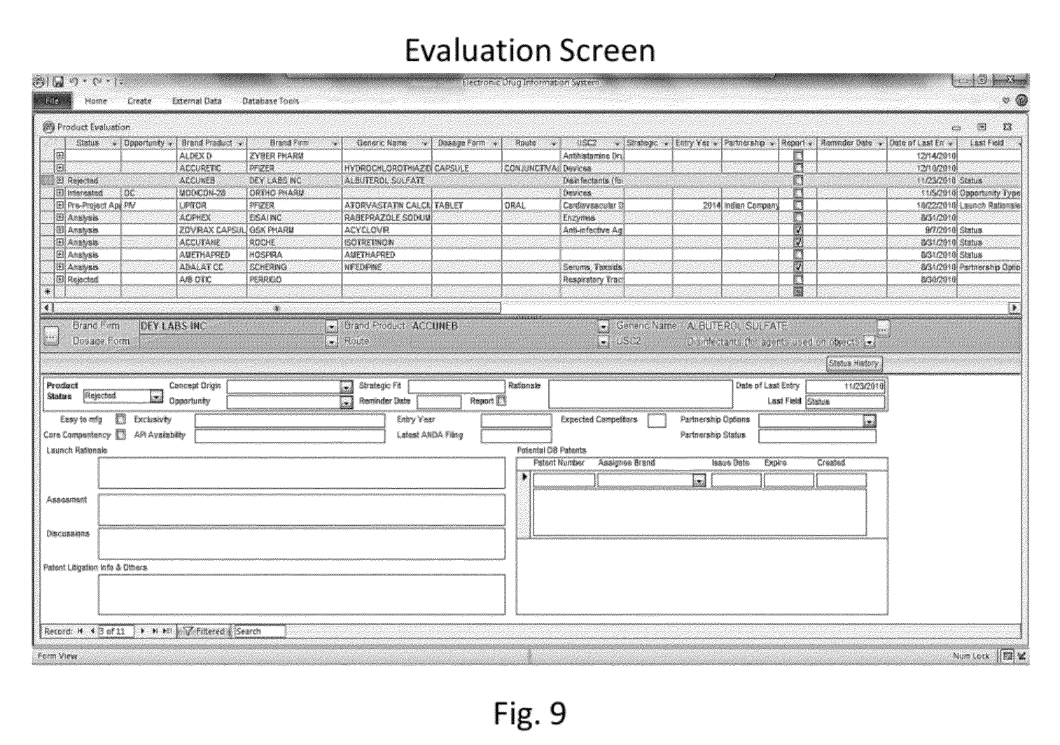

The evaluation screen shown in FIG. 9 is used for additional user input on products that were identified in the screens described above and that may be of particular interest to a manufacturer. Elements on the evaluation screen are linked with the same elements listed on the product screen. The linking between the elements on the screens allows for an easy back and forth between user-entered data and the sales, units, pricing, FDA dates and competition.

The evaluation screen has fields that are pre-populated based on the active pharmaceutical name, the available dosage, routes and forms of the drug under consideration. These fields are filtered based on the brand's characteristics.

Manufacturers traditionally track the pharmaceutical products that they are making. However, the manufacturers do not have them tied to FDA, IMS and FDB data in an integrated, live database, and they cannot compare or otherwise evaluate their products relative to other products in the market. Most manufacturers track their products in Excel or another separate database which requires loads of manual work, including cutting and pasting data, in order to evaluate their products. In comparison, the EDIS software allows manufacturers to evaluate their products relative to other products in the market in real time.

The EDIS software allows for multiple users and tracks who enters what data, where the data is entered and when the data is entered. The EDIS software can track all changes made in the database for user defined fields, and a user can call up the history of a product.

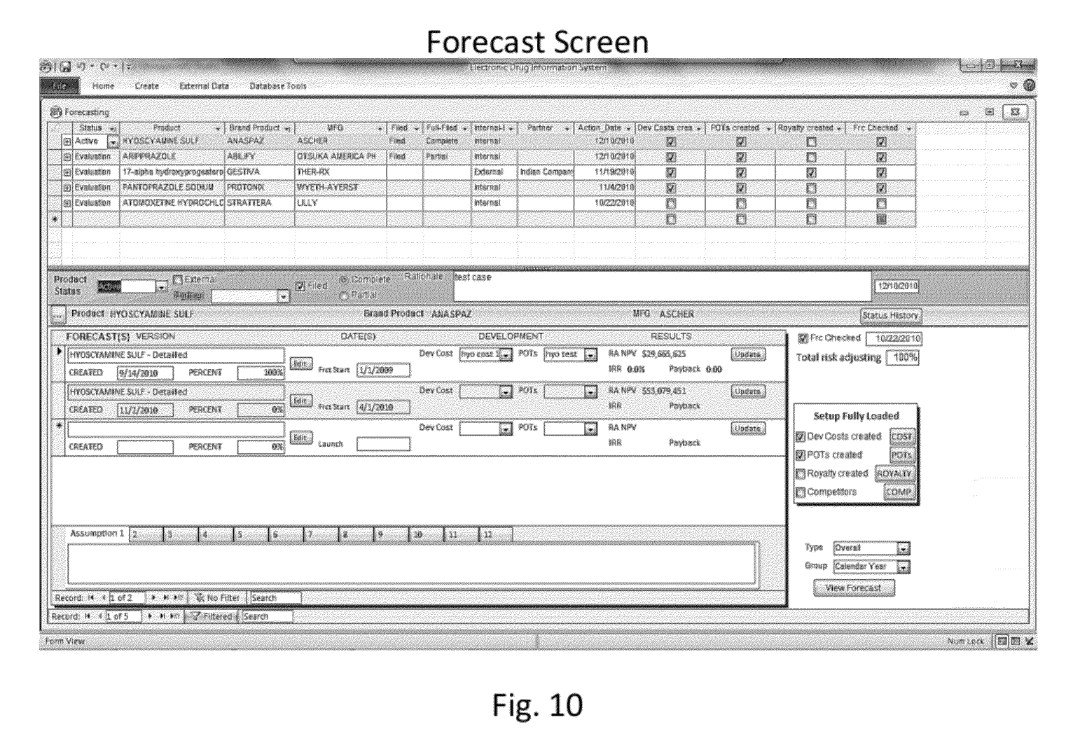

The EDIS software leverages the merged data records that it has in its database to create forecasts. The EDIS software creates templates of past introductions of generic drugs. For a product that a manufacturer may want to produce, such as one that is coming off patent, the user picks a past generic introduction as a template for the product that is to be forecasted. The user can use the EDIS system to obtain a listing of all current patents to overcome (if applicable) from the FDA linkages and a listing of all the SKUs for the product to be forecasted (including strength, size, dose and three years of sales data). From the selected template, the user can choose how the market share grows/shrinks by month over month changes, the user can also alter the size of the market in reviewing the template's month over month change as well as the month over month price changes of the template. The template also includes the initial prices of the SKU(s) relative to the brand and the timing of each competitor's market entrance by month starting with the first generic. The template also displays the brand's Class of Trade and assumes the new generic will sell in a similar manner, and this is also a monthly figure. Selection options for the user are shown on the forecasting screen in FIG. 10, and all of the forecast values are editable by the user, thereby permitting the users to deviate from the template according to the particular users' needs and analytical capabilities.

Once the template has been filled out, EDIS evaluates the launch date of the new generic versus the last date of data in the system. If there is a gap, EDIS instructs the user to forecast the targeted brand drug to the first launch date of a generic. EDIS will create four different regression analyses (editable) to help the user forecast the brand to the first generic launch date.

For every brand/generic combination, the EDIS software can build a picture of how the generic pharmaceutical products entered the market: 1. who was first, what price did they have and how fast did they gain market share; 2. who was next, what was their price and market share; 3, how did the second introduction affect the first manufacture's market share, how did pricing change with the second entry and so on. Most companies have all this data, but no one can combine it in a way to form a picture of how a market matured. The templates created by the EDIS software are pattern recognition tools for the pharmaceutical markets. By using the GCN, the EDIS software can link brand products and their associated generics. The EDIS software takes this data and builds a month over month table of each product that includes the sales of each NDC/SKU and their prices. EDIS rolls this data up from the NDC/SKU level and can present a picture of each generic's entrance into the market for any given brand.

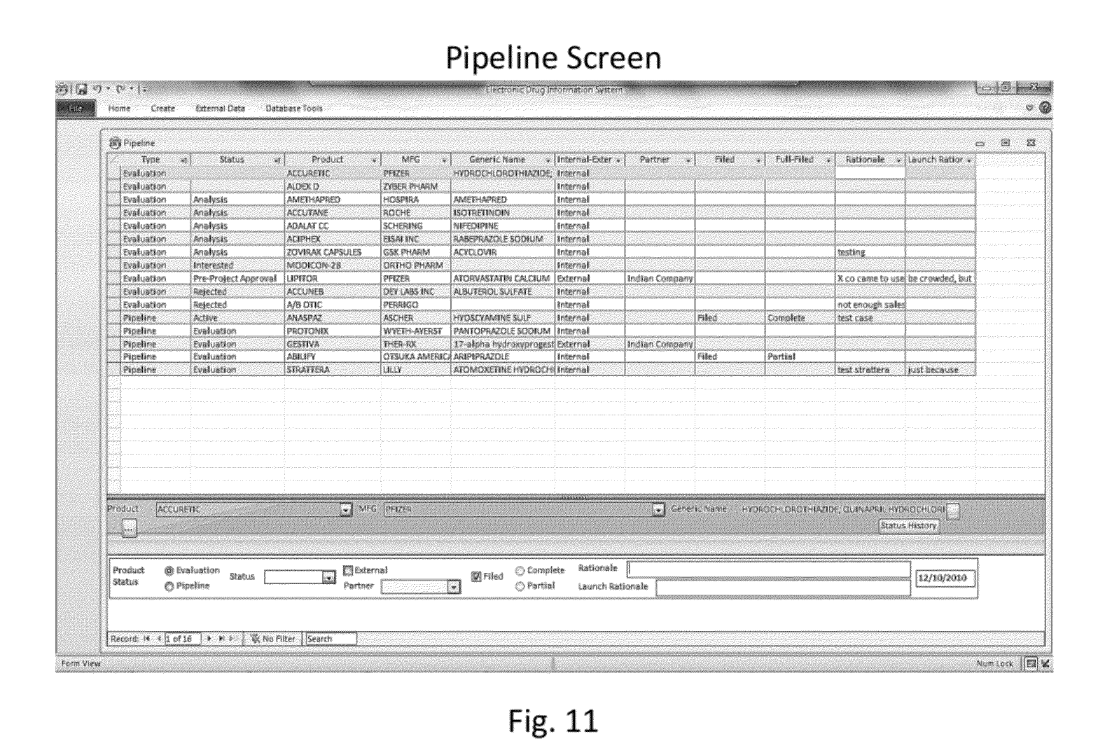

The pipeline screen shown in FIG. 11 is a tool for product line segmentation between active seeking products and just evaluating.

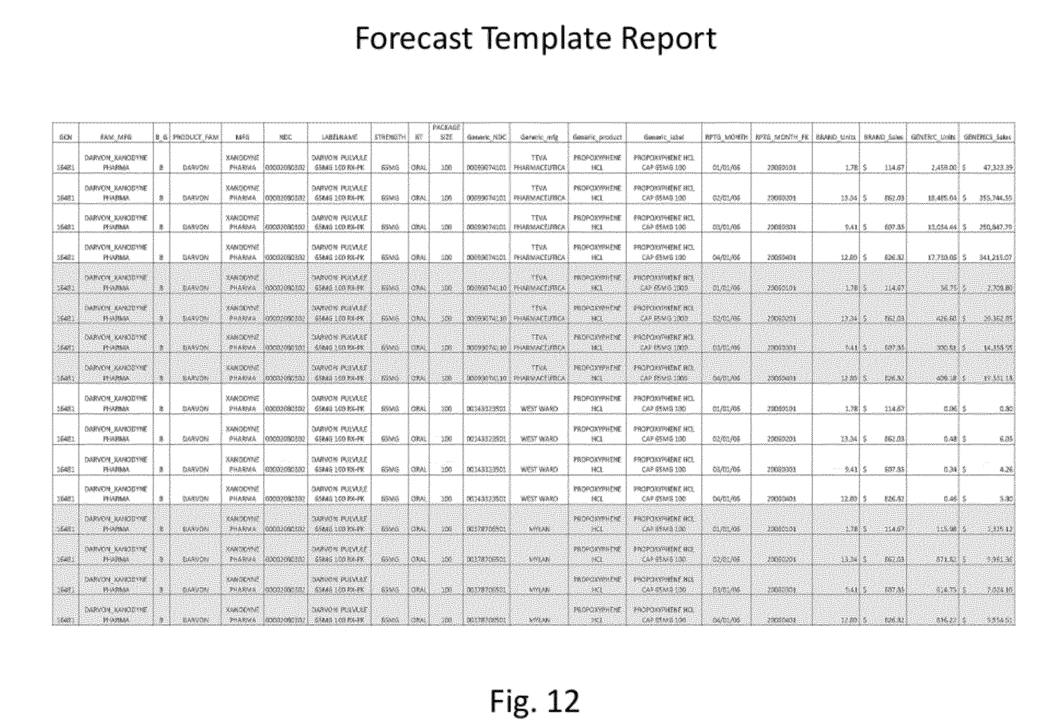

An example of a forecast template report is provided in FIG. 12. The EDIS software uses the mbg_detail table to create the templates that represent how generics entered the market. For each brand NDC, the competitor information is matched by GCN for each month. Using the data from this table, the EDIS software can sum all the units for generics and group by the brand sales to show substitution patterns. With the pricing table by NDC by month, the EDIS software can lookup pricing to get the generics to brand WAC price ratio for each record.

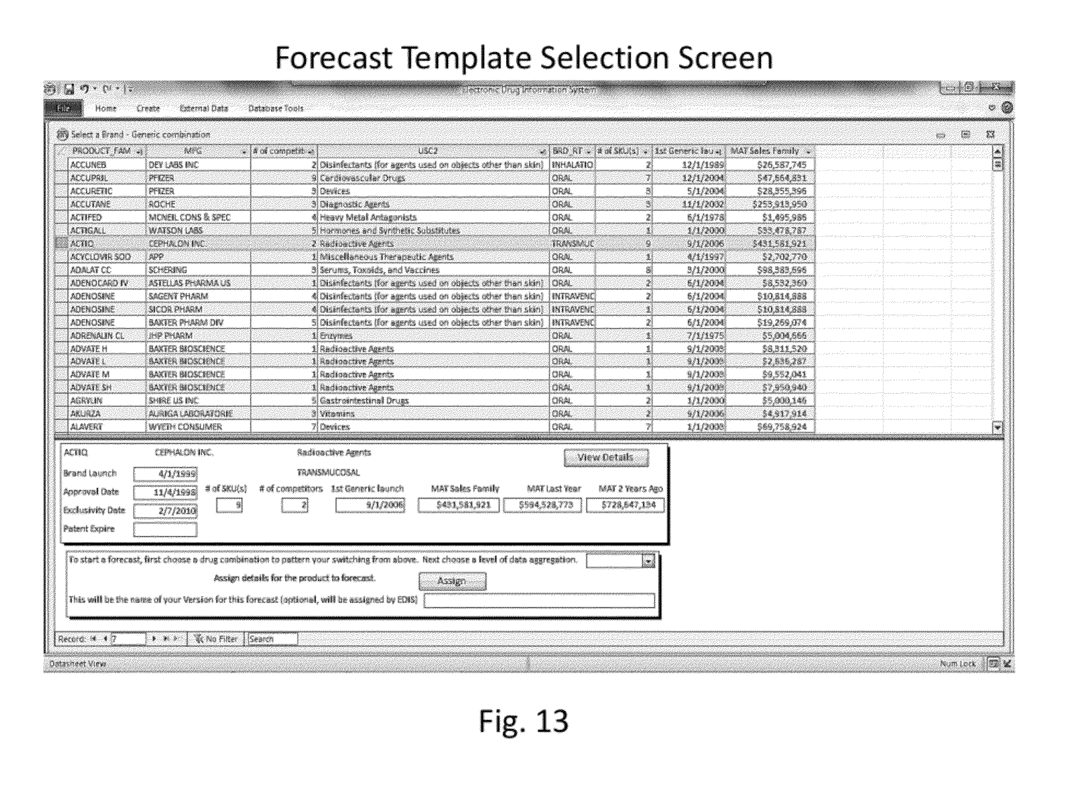

A forecast selection screen is shown in FIG. 13. The screen provides a list of the brand generic combinations, product families in EDIS by product, manufacturer, number of competitors, number of SKUs, USC code, route, date of first generic and MAT current sales for the product family. It also shows the date that the brand launched, the date that the brand was approved and the date of the first generic to market. A user can pull up a listing of all cardiovascular drugs that have gone generic with three competitors to use as a template for their new cardiovascular drug.

Once again, without the EDIS software, a monumental amount of manual work would be required to create this list. After creating all the brand/generic combinations, counting the competitors and determining prices, the user would need to look up every NDC and pull the unit data from IMS by month. Next, the user would have to look up every product in the EOB to get the approval dates.

The EDIS software shows the charts for each combination that contain generic fill rate, market shares, sales dollars and units for the entire product family or you can break it down to the NDC level. Accordingly, the EDIS software evaluates past experience as a predictor of future events. Even if some manufacturers are tracking the historical data, they are not using it as a forecast.

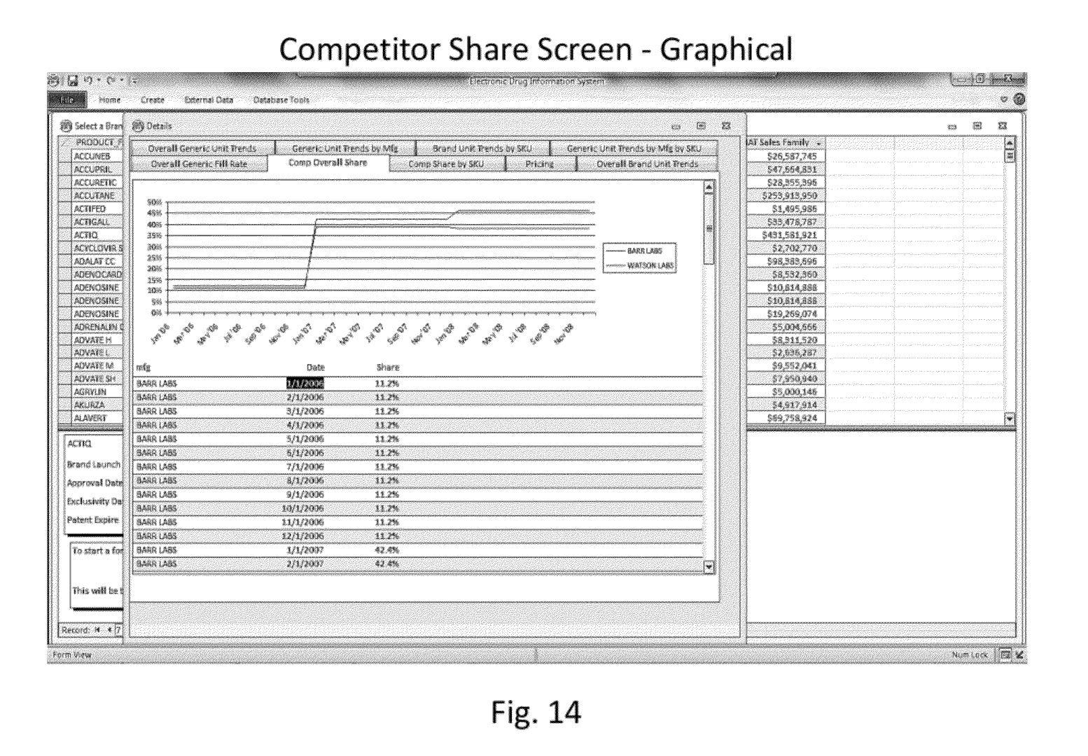

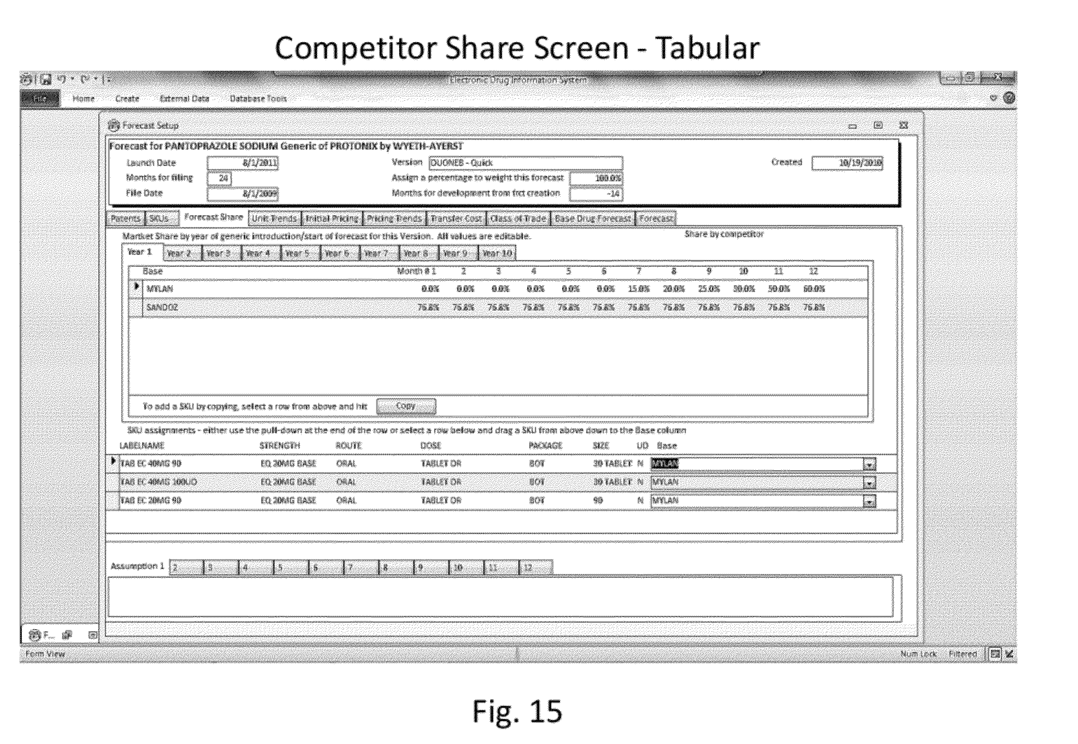

Once a forecast template is selected, the EDIS software will display the share for each competitor of the template, and the user can select which competitor's data to use for their own forecast. The EDIS software can display the information in a graphical format as shown in FIG. 14 or in tabular format as shown in FIG. 15. The competitor share is displayed as a month over month change by year. The user can select whether to view the data at the competitor level or the SKU level. This works the same for the unit trends and pricing changes by month as well. The initial pricing is also displayed as the generics percent of brand's WAC for the template.

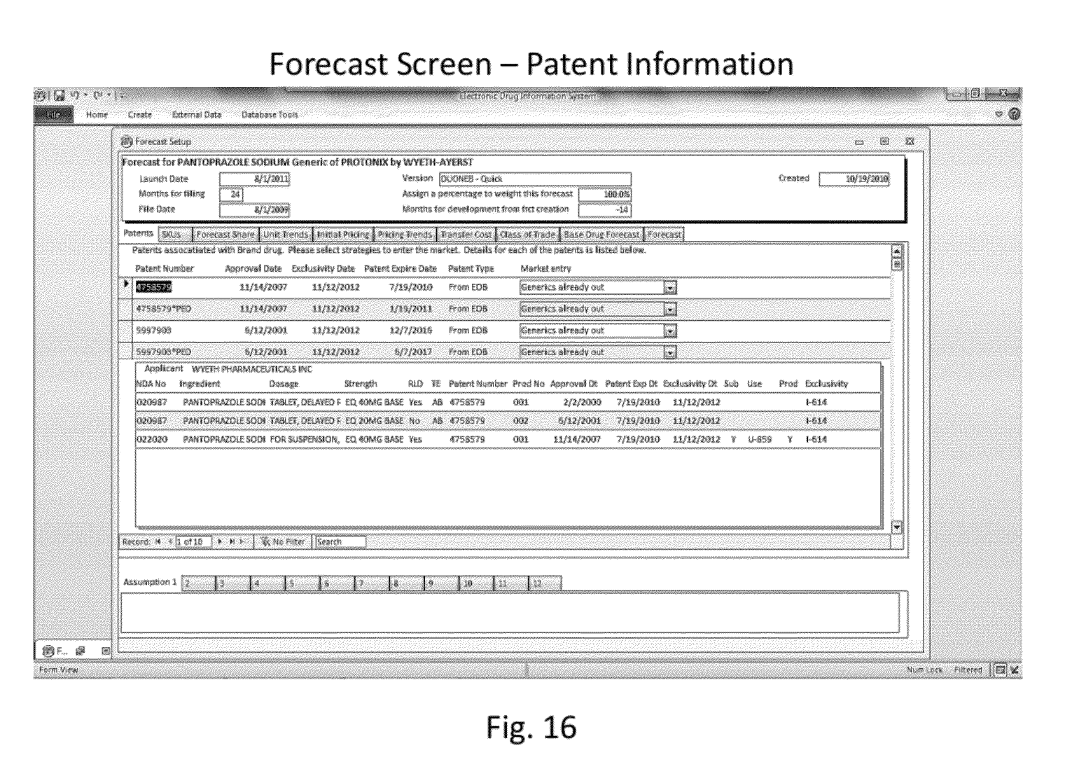

The EDIS software makes the forecast creation a simple task once a template is picked, the user simply chooses a scenario that could be comparable to the current market and use that for the product they are forecasting. The EDIS software allows the user to edit the values to make the forecast different than the historical records. As shown in FIG. 16, the EDIS software also looks up the patent information for the drug of the forecast for the user.

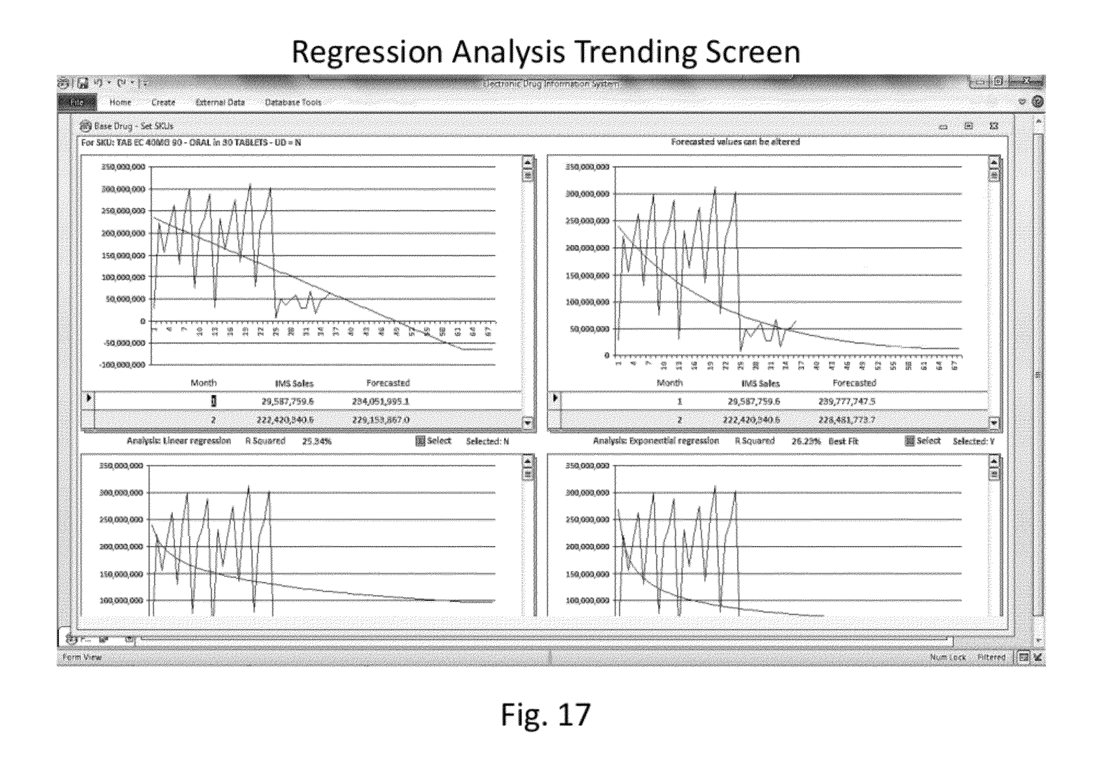

Once all the selections have been made, there is a gap of data because the sales and unit data in the EDIS database is limited to historical and current data records, but the user is forecasting a future event, such as when a patent expires in a number of years. Accordingly, there are holes in the data for the drug that the user wants to forecast. As shown by the regression analysis trending screen in FIG. 17, the EDIS software creates four regressions for the user to choose from in order to trend the brand drug to the first generic entry, and then the forecast actually runs.

As an example of using a regression analysis to span a gap in the data, consider a forecast performed in 2010 for a new generic drug that should start production in the year 2014 and EDIS only has data to the end of 2009. There is a gap from all of 2010 to the time of launch where the brand will be selling, and the manufacturer needs to base the forecast off the brand's most recent activity. A regression analysis is created for the data that is in the EDIS database. Four curves are displayed, with the data for a linear regression, power regression, exponential regression and logarithmic regression. The curves can be created based on either sales dollars or units sold. Each regression shows an R squared so the forecaster can pick the best fit for the data. The user also has the ability to edit the regression values.

Once a regression is selected, the user will look at the brand pricing. All past prices for the brand are displayed and the user can create price increase/decreases for the brand's gap in data. Next, the brand drug forecast for the gap in the data is created. Charts display the sales dollars and units for the brand by year, by year by SKU and by month by SKU. Next, the user looks at the actual forecast. For each SKU, by month the EDIS software displays the market share, total units, price, price change and distribution for sales. The user has the ability to view all price details for WAC, distributor, retail, contract and average selling price. The user can also view the summary of the forecast that includes charts for total market units and the units sold and the other chart that has gross sales, net sales and gross profit dollars. The data for the charts is also displayed by month. The user also have the ability to see the same data by SKU.

The forecast is also using the merged FDA data by bringing in the patents for the drug being forecasted. The patents are listed by each SKU they cover and the user notates how they will get around each patent. This is unique in the way that the user does not have to look up each patent in the EOB, all they have to do is pick a drug to forecast and the patents automatically show up without any manual lookups.

For each product being forecasted, the user can enter in development costs, probability of technical success, royalty setups for third party manufacturing and competitor information if the manufacturer has a third party royalty contract based on the number of competitors.

For each forecast for each product, the user can enter a likelihood factor which is a chance of the forecast actually happening. Different forecasts can be assigned different likelihood factors. For example, a product which has two (2) forecasts the odds of the first forecast happening can be rated with a likelihood factor of 75% whereas a second forecast can be rated with a likelihood factor 25%, i.e., three times less likely relative to the first forecast. Examples of the weighting factors are shown in FIGS. 10 and 15. In FIG. 10, each of the forecasts can be assigned the weighting factor in the percent field under the Forecast Version. In FIG. 15, the user is provided with a field in which to assign a percentage to weight the forecast.

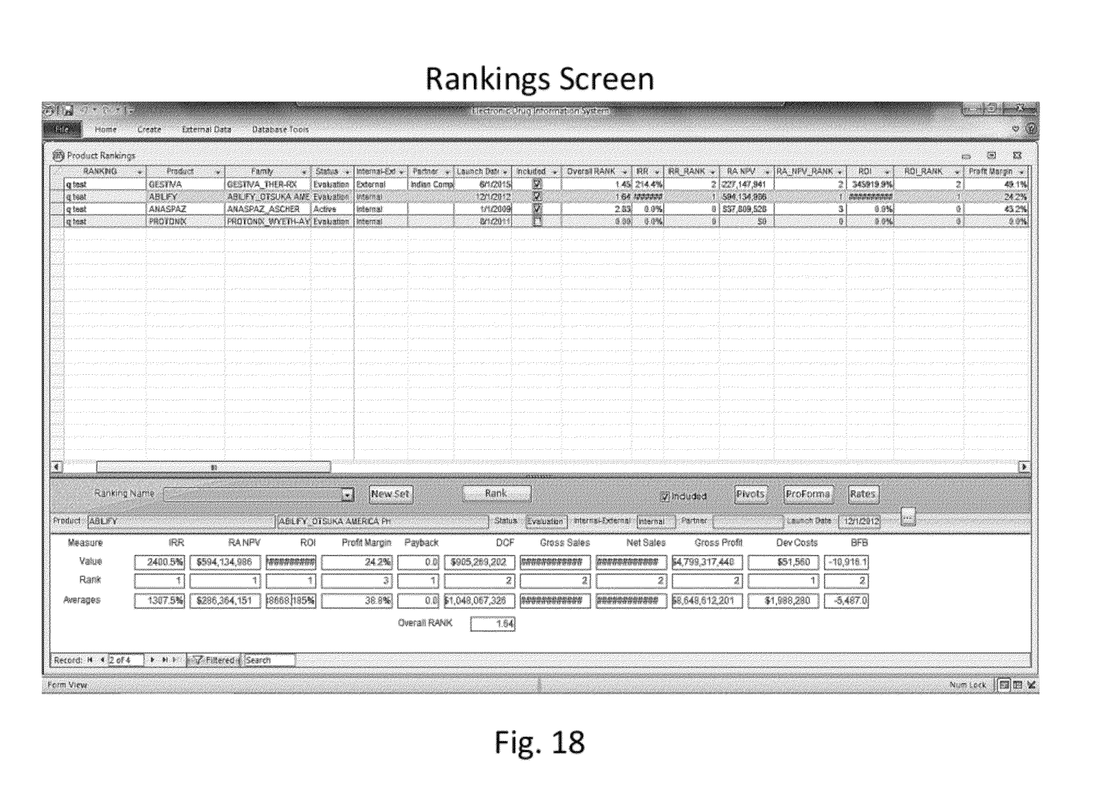

By assigning the percentages to the forecasts, the EDIS software will take a simple average of all the forecasts for each product to display the likely values for all the forecasted products. As shown by the ranking screen of FIG. 18, the EDIS software ranks the forecasts to see which one is the highest priority based on several financial metrics, including ROI, Risk Adjusted NPV, IRR, Profit Margin, Time to Payback, Discounted Cash Flows, Gross Sales, Net Sales, Gross Profit, Development Costs and Bang for the Buck (Risk Adjusted NPV divided by Development Costs). Using the results from the rankings screen, a pharmaceutical company can target its biggest opportunities. Several charts and graphs come out of the rankings as well.

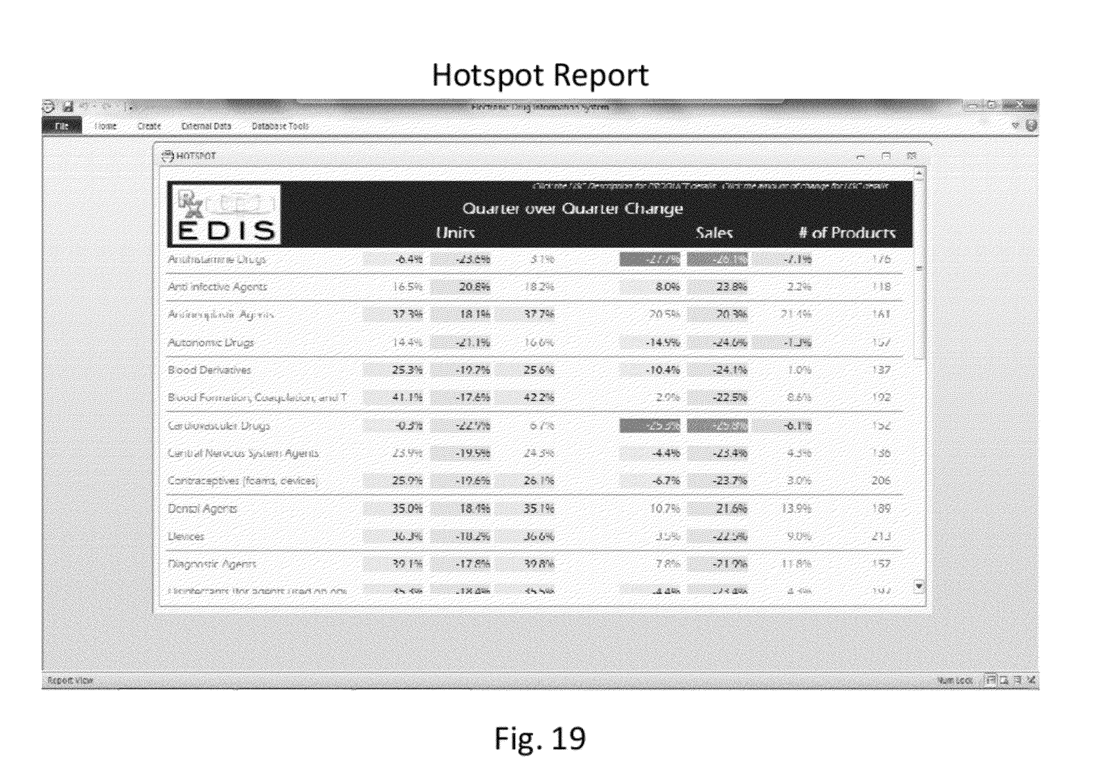

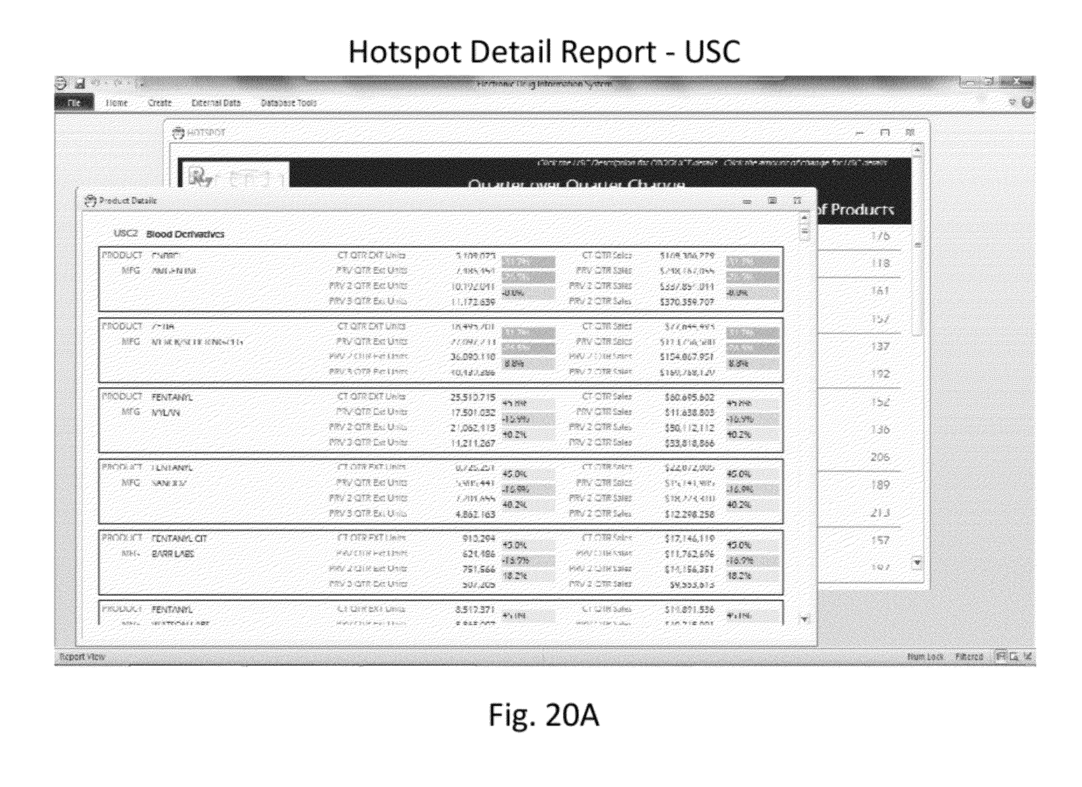

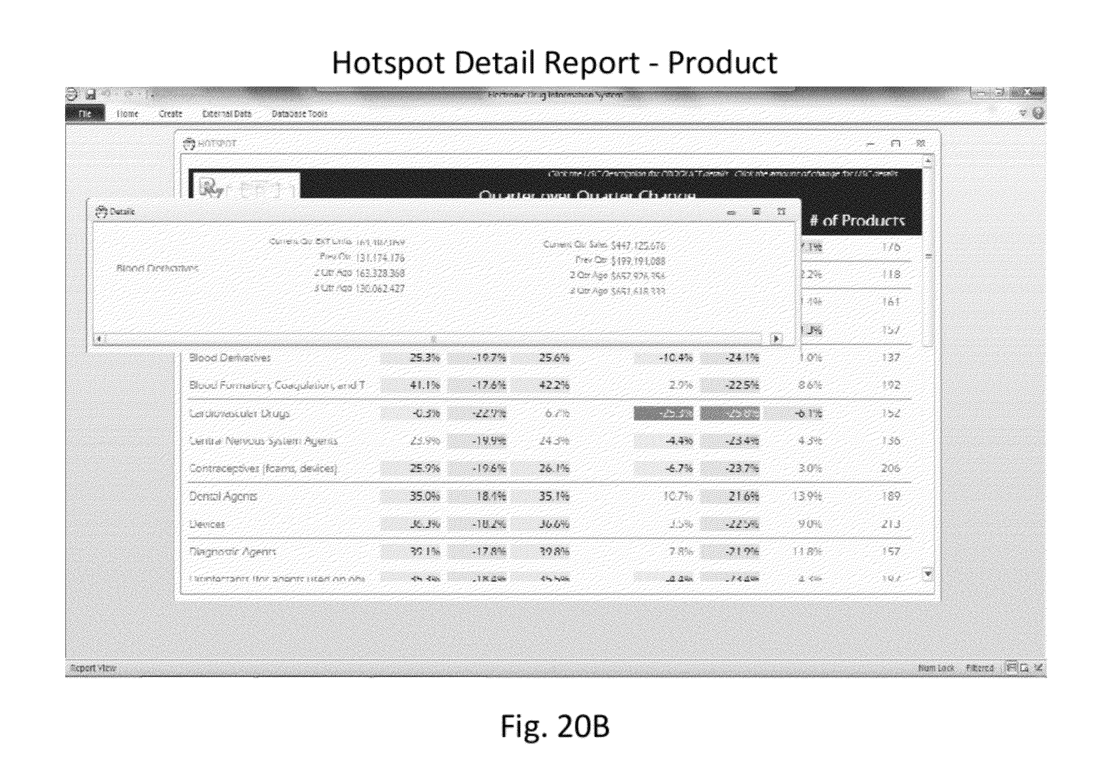

The hotspots report shown in FIG. 19 summarizes the quarterly changes in units and sales dollars by Uniform System of Classification (USC) code and quickly informs the user how the USCs are trending. Anything that is growing 25% or more is yellow, anything that is 0% to −25% is light blue, and anything that is shrinking by more than 25% is dark blue. The number of products in each USC is displayed as well. By clicking on the USC, the user can see the data that built up the changes, as shown in FIG. 20A. By clicking on a change value, the user can see all the product data that built up the change, as shown in FIG. 20B. The hotspots report summarizes the IMS data in a unique way according to the present invention's evaluation of the trending of the pharmaceutical data records.

Based on the description of the invention and examples provided above, it will be appreciated by skilled technologists that the EDIS software marries previously isolated datasets into a merged database that results in more efficient, clear and expedited drug development strategies. Answers to “what if” questions are quicker and more accurate than had previously been possible with the isolated datasets, and all angles of inquiry across the competing manufacturers, drug launch timing, competing drugs and therapeutic areas can be extracted by most analysts in the organization. Using the merged pharmaceutical records, the EDIS software creates a knowledge base that provides valuable insights to users at all levels within pharmaceutical manufacturer organization, from the analysts to the managers and the executives. Once all the data has been merged, it is no longer raw data but information that can be used to make corporate or product decisions.

The EDIS database maintains and updates the historical pharmaceutical data records in a single location along with user created product assessments and product forecasts that have not been considered when the data had been distributed in multiple databases. Before the EDIS software had merged the pharmaceutical records into a single database and provided analytical tools for examining the merged records, it would have been inefficient and cumbersome to perform such evaluations on the isolated datasets in their own individual databases. Without the present invention, many operations in forecasting pharmaceutical compounds must be performed manually. The data merging methodologies of the present invention eliminate the previous incompatibility of the isolated datasets, particularly the nonconforming construct of the NDC data, which allows the present invention to automate most of the operations.

To extract the correct data from the isolated datasets using the methods before the present invention, the analysts needed to understand all of the intricate details of each piece of software which is being used for the extraction. Also, the analyst would need to know which data is the subject of the search and when it is found, the analyst would have to manually combine the data with the data that had been extracted by the software for the other datasets. Forecasting became a time intensive task which required examining the data from these multiple sources and manually combining the data because the current products do not allow for complex querying of the entire pharmacy industry at one time. With the EDIS software and merged database, all of the pharmaceutical data records are in one location, ready for action with a base of knowledge that can be used by personnel who are not necessarily market analysis experts, including the executive management.

The present invention is unique in the pharmaceutical industry because information technology experts in this industry traditionally have believed that it is not possible to correctly integrate the pharmaceutical data records in a cost-efficient manner. The executives and analysts do not typically think of attempting to join the data. Even if a compilation of the data had been proposed, with the traditional thinking in the pharmaceutical industry, the result would have been more manpower for the data integration rather than the automated approach of the present invention. In the present invention, the heavy lifting is done by the EDIS software. Accordingly, it will be appreciated that with the present invention, an analyst's time is not wasted finding data, organizing data, creating and re-creating data pulls and product rankings. Another benefit of the present is better-targeted products.

It will also be appreciated that alternative sources can be used for the data that is merged into the EDIS database. For example, the user can select the vendor of the sales and units data, such as IMS or Wolters Kluwer. Although the First Data Bank data is currently the only source that provides a GCN as the bridge from generics to brands, the present invention can also operate by replicating the GCN with data from the FDA. Also, the First Data Bank pricing can be replaced by using the sales and units data, but at the present time, this replacement would not be as reliable as the First Data Bank data.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method for efficiently evaluating pharmaceutical data, comprising:
receiving at a computer database and from at least one source a first set of pharmaceutical records relating to a plurality of pharmaceutical compositions, wherein said first set is comprised of manufacturer data, composition data, and market information, wherein said market information is selected from the group consisting of sales data, unit data, pricing data, and any combination thereof;
receiving at said computer database and from another source a second set of pharmaceutical records relating to said pharmaceutical compositions, wherein said second set is comprised of regulatory records relating to said pharmaceutical compositions;
matching said pharmaceutical records in said second set with said pharmaceutical records in said first set in a computer processor, wherein said matching step is selected from a group of steps selected from the group consisting of matching codes in said sets, replacing non-numeric characters in said codes with numeric characters and matching said codes between said sets, matching trade names in said sets, matching trade names combined with a labeler code in said sets; matching NDC-version trade names in said sets, matching active ingredient name combined with a labeler code in said sets, matching NDC-version active ingredient name combined with a labeler code in said sets, and any combination thereof;
merging said pharmaceutical records according to said matching step; and
storing said pharmaceutical records in a joined data set.

2. The invention of claim 1, further comprising the steps of displaying said merged pharmaceutical records on a display and filtering said merged pharmaceutical records in said computer processor according to a first data element from said first set of pharmaceutical records.

3. The invention of claim 2 further comprising further filtering said merged pharmaceutical records in said computer processor according to a second data element from said second set of pharmaceutical records.

4. The invention of claim 1, further comprising the step of automatically updating said pharmaceutical records in said computer processor according to an update time associated with said first set of records.

5. The invention if claim 4 further comprising automatically updating said pharmaceutical records in said computer processor according to an update time associated with said second set of records, wherein said update time associated with said second set of records differs from said update time associated with said second set of records.

6. The invention of claim 1, further comprising the steps of calculating a historical trend of said merged pharmaceutical records in said computer processor for at least one generic pharmaceutical composition; creating a market entry template in said computer processor based on said historical trend; and applying said market entry template in said computer processor to a current pharmaceutical composition to create a forecast.

7. The invention of claim 6 further comprising creating a plurality of market entry templates in said computer processor based on said historical trend; and applying at least one of said plurality of market entry templates in said computer processor to a current pharmaceutical composition to create a forecast with.

8. The invention of claim 6, further comprising the steps of calculating said historical trend in said computer processor based on a plurality of generic pharmaceutical compositions; and performing a regression analysis in said computer processor for a predicted trend during a time period between a current date and a future date for a start of said forecast.

9. The invention of claim 8, wherein said future date corresponds with a generic launch date.

10. The invention of claim 1, further comprising the steps of creating a plurality of brand name product families from said first set of pharmaceutical records; creating a set of generic product families corresponding with said brand name product families; calculating in said computer processor moving annual totals; constructing in said computer processor main tables for said first set of pharmaceutical records; creating in said computer processor a list of valid codes for said first set and said second set of pharmaceutical records; building in said computer processor competitor tables; summing sales and counting products in said computer processor for each manufacturer; summing sales, counting competitors, and summing competitor sales in said computer processor for each product family; defining patent, exclusivity and approval dates in said computer processor for each product family; and summarizing in said computer processor brand-generic combinations.

11. A method for efficiently evaluating pharmaceutical data, comprising:
storing a market entry template in a computer database;
calculating a plurality of historical trends of pharmaceutical records for a plurality of generic pharmaceutical compositions in a computer processor;
selecting said market entry template from said computer database based on said historical trends; and
applying said market entry template to a current pharmaceutical composition in said computer processor to create a forecast.

12. The invention of claim 11 further comprising storing a plurality of market entry templates in said computer database; and applying one of said plurality of market entry templates to said current pharmaceutical composition in said computer processor to create said forecast.

13. The invention of claim 11 further comprising the step of performing a regression analysis in said computer processor for a predicted trend during a time period between a current date and a future date for a start of said forecast.

14. The invention of claim 13, wherein said future date corresponds with a generic launch date.

15. The invention of claim 11 further comprising the steps of selecting a category of pharmaceutical compositions corresponding with said current pharmaceutical composition and restricting in said computer processor said pharmaceutical records in said historical trend to said category.

16. The invention of claim 11 further comprising the steps of tracking entries and selections by a plurality of users in said computer processor; tracking changes made to user defined fields in said computer processor; recalling a history of a product in said computer processor; displaying on a display a share for a plurality of competitors in said market entry template; identifying in said computer processor one of said competitors for said selected market entry template used to create said forecast, assigning a likelihood factor to a plurality of forecasts in said computer processor; ranking said plurality of forecasts in said computer processor; and evaluating in said computer processor a plurality of changes in sales over time periods and providing a trending report corresponding with said changes.
